(19) United States
(12) Patent Application Publication
(10) Pub. No.: US 2024/0404282 A1
(43) Pub. Date: Dec. 5, 2024

(54) IMAGE SENSOR, DATA PROCESSING DEVICE, AND IMAGE SENSOR SYSTEM

(71) Applicant: SONY SEMICONDUCTOR SOLUTIONS CORPORATION, KANAGAWA (JP)

(72) Inventor: TAKAHIRO MIYAZAKI, KANAGAWA (JP)

(21) Appl. No.: 18/697,302

(22) PCT Filed: Oct. 5, 2022
(86) PCT No.: PCT/JP2022/037204

§ 371 Date: Mar. 29, 2024

(30) Foreign Application Priority Data
Oct. 8, 2021 (JP) 2021-166417

(51) Int. Cl. G06V 20/40; G06T 7/20; G06V 10/25; G06V 10/60

(52) U.S. Cl. CPC G06V 20/44; G06T 7/20; G06V 10/25; G06V 10/60

(57) ABSTRACT

The present disclosure relates to an image sensor, a data processing device, and an image sensor system that allow versatility to be enhanced.

An image sensor includes an event detection unit configured to detect a luminance of light received by a photodiode and output a luminance signal indicating a luminance value thereof, an event detection unit configured to obtain a difference between the luminance value represented by the luminance signal and a prescribed reference value, detects an occurrence of an event and outputs event data indicating a content of the event when the difference exceeds an event detection threshold on a positive side or an event detection threshold on a negative side, and an additional information generation unit configured to generate frame information to be added to a frame as additional information additionally provided to the event data on the basis of the event data, and a data transmission unit configured to transmit data in such a frame structure that the frame information is a part of embedded data and the event data is a part of payload data. The present technology can be applied for example to an EVS (Event based Vision Sensor).

### TECHNICAL FIELD

The present disclosure relates to image sensors, data processing devices, and image sensor systems, and particularly to an image sensor, a data processing device, and an image sensor system that can achieve higher versatility.

### BACKGROUND ART

In recent years, development of image sensors that detect a luminance change in each pixel as an event in real time (hereinafter referred to as the EVS (Event based Vision Sensor)) has been underway.

For example, PTL 1 discloses a sensor architecture that allows sampling to be performed by frame-based, and event-based methods and a hybrid method between frame-based and event-based methods.

### CITATION LIST

### Patent Literature

### [PTL 1]

Japanese Translation of PCT Application No. 2017-535999

### SUMMARY

### Technical Problem

According to conventional techniques, data output from an EVS does not have a fixed output format due to its event-driven nature, and therefore a new evaluation system to receive such data should be designed.

With the foregoing in view, the present disclosure is directed to enhancing the versatility of the EVS.

### Solution to Problem

An image sensor according to one aspect of the disclosure includes an event detection unit configured to detect an occurrence of an event as a luminance change in light received by a photodiode and a data transmission unit configured to transmit data in such a frame structure that event data indicating a content of the event is a part of payload data and frame information to be added to a frame as additional information additionally provided to the event data is a part of embedded data.

A data processing device according to an aspect of the present disclosure includes a data receiving unit configured to receive data in such a frame structure that event data indicating a content of an event as a luminance change in light received by a photodiode is a part of payload data and frame information to be added to a frame as additional information additionally provided to the event data is a part of embedded data and an event-related data processing unit configured to perform data processing related to the event by referring to the frame information.

An image sensor system according to one aspect of the disclosure includes an image sensor having an event detection unit configured to detect an occurrence of an event as a luminance change in light received by a photodiode and a data transmission unit configured to transmit data in such a frame structure that event data indicating the event content as a part of payload data and frame information to be added to a frame as additional information provided to the event data is a part of embedded data and a data processing device having a data receiving unit configured to receive the event data and the frame information, and an event-related data processing unit configured to perform data processing related to the event by referring to the frame information.

According to one aspect of the present disclosure, an occurrence of an event as a luminance change in light received by a photodiode is detected, and data is transmitted in such a frame structure that event data indicating the content of the event is a part of the payload data, and frame information to be added to the frame as additional information additionally provided to the event data is a part of embedded data. The event data and the frame information are received, and event-related data processing is performed by referring to the frame information.

### BRIEF DESCRIPTION OF DRAWINGS

FIG. 1 is a block diagram of an exemplary configuration of a sensor system according to an embodiment to which the present technology is applied.

FIG. 2 is a block diagram of an exemplary configuration of an EVS with a 3-chip stacked structure.

FIG. 3 is a diagram of an exemplary frame configuration of event data for one frame.

FIG. 4 is a diagram of an example of embedded data arrangement.

FIG. 5 is a diagram of a first exemplary frame configuration in which three frames of event data are concatenated into one frame.

FIG. 6 is a diagram of a second exemplary configuration in which three frames of event data are concatenated into one frame.

FIG. 7 is a block diagram of a first exemplary configuration of an additional information generation unit.

FIG. 8 is a diagram for illustrating a time stamp, the number of frames, and the amount of data.

FIG. 9 illustrates the presence or absence of flicker and event data.

FIG. 10 is a diagram of an exemplary frame configuration that store frame information.

FIG. 11 is a block diagram of an exemplary configuration of a data processing device.

FIG. 12 is a block diagram of an exemplary configuration of the additional information generation unit corresponding to an arbiter type device.

FIG. 13 illustrates processing performed by the frame generation unit.

FIG. 14 is a block diagram of a second exemplary configuration of the additional information generation unit.

FIG. 15 is a diagram of an exemplary frame configuration that stores line information.

FIG. 16 is a diagram of another exemplary frame configuration that stores line information.

FIG. 17 is a block diagram of an exemplary configuration of the additional information generation unit corresponding to an arbiter type device.

FIG. 18 is a block diagram of a third exemplary configuration of the additional information generation unit.

FIG. 19 is a diagram of an exemplary frame configuration that stores pixel information.

FIG. 20 illustrates a method for transmitting pixel information.

FIG. 21 is a block diagram of an exemplary configuration of the additional information generation unit corresponding to an arbiter type device.

FIG. 22 is a block diagram of an exemplary configuration of a sensor system in which the physical layer can be switched between serializer and de-serializer.

FIG. 23 is a block diagram of an exemplary configuration of a sensor system in which the physical layer can be switched in the EVS and the data processing unit.

FIG. 24 illustrates an exemplary configuration of an electronic device that includes an EVS.

FIG. 25 is a block diagram of an overall exemplary configuration of an EVS.

FIG. 26 is a circuit diagram of an exemplary configuration of an event pixel.

FIG. 27 is a block diagram of an exemplary configuration of a scan type EVS.

FIG. 28 is a block diagram of an exemplary configuration of a sensor system that includes a plurality of sensors.

FIG. 29 illustrates a first example of the control result of image concatenation.

FIG. 30 illustrates a second example of the control result of image concatenation.

FIG. 31 illustrates a third example of the control results of image concatenation.

FIG. 32 illustrates a fourth example of the control results of image concatenation.

FIG. 33 illustrates a fifth example of the control result of image concatenation.

FIG. 34 illustrates an example of data transmitted by a first transmission method.

FIG. 35 illustrates an example of Embedded Data transmitted by the first transmission method.

FIG. 36 is a view of examples of image sensor applications.

### DESCRIPTION OF EMBODIMENTS

Hereinafter, specific embodiments to which the present disclosure is applied will be described in detail with reference to the drawings.

### <Exemplary Configuration of Sensor System>

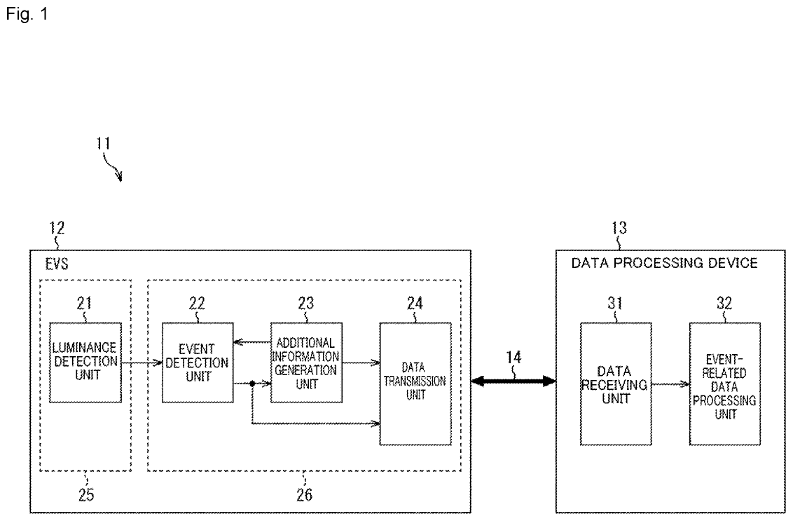

FIG. 1 is a block diagram of an exemplary configuration of a sensor system 11 according to one embodiment to which the present technology is applied.

In FIG. 1, the sensor system 11 includes an EVS 12 and a data processing device 13 which are connected via a data bus 14.

The EVS 12 is an image sensor that detects a luminance change in each pixel as an event in real time and transmits event data indicating the content of the event to the data processing device 13 via the data bus 14. The EVS 12 includes a luminance detection unit 21, an event detection unit 22, an additional information generation unit 23, and a data transmission unit 24.

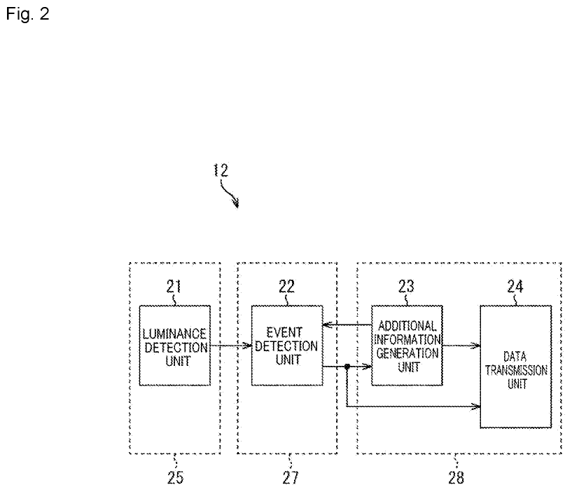

For example, the EVS 12 can have a stacked structure including two chips stacked on each other: a pixel chip 25 in which the luminance detection unit 21 is provided and a signal processing chip 26 in which the event detection unit 22, the additional information generation unit 23, and the data transmission unit 24 are provided. Here, the event detection unit 22 is an analog circuit that serves as an AFE (Analog Front End). Therefore, as shown in FIG. 2, the EVS 12 can have a stacked structure including three chips stacked on each other, a pixel chip 25 in which the luminance detection unit 21 is provided, an AFE chip 27 in which the event detection unit 22 is provided, and a logic chip 28 in which the additional information generation unit 23 and the data transmission unit 24 are provided.

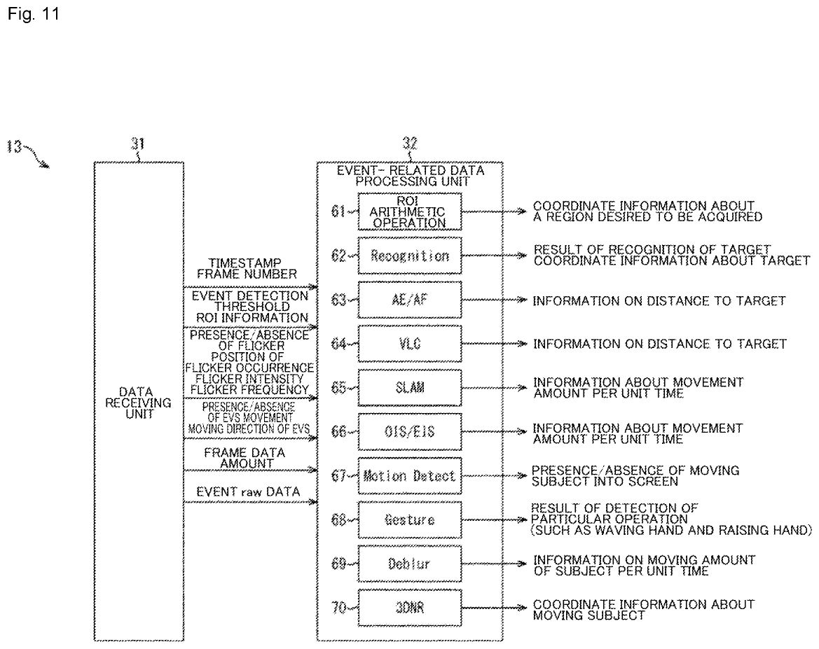

The data processing device 13 includes, for example, an application processor and an FPGA (Field Programmable Gate Array). The data processing device 13 performs various kinds of data processing on the event data transmitted from the EVS 12 and obtains various kinds of information related to the event. The data processing device 13 includes a data receiving unit 31 and an event-related data processing unit 32 which will be described in detail with reference to FIG. 11.

The data bus 14 transmits and receives data between the EVS 12 and the data processing device 13 according to CSI-2 (Camera Serial Interface-2), an interface standard by the MIPI (Mobile Industry Processor Interface) alliance.

The luminance detection unit 21 includes a photodiode provided for each pixel, detects the luminance of light received by the photodiode, and supplies a luminance signal indicating the luminance value to the event detection unit 22.

The event detection unit 22 calculates the difference between the luminance value indicated by the luminance signal supplied from the luminance detection unit 21 and a prescribed reference value and detects the occurrence of an event when the difference exceeds a positive side event detection threshold or a negative side event detection threshold. Upon detecting an event occurrence, the event detection unit 22 outputs event data indicating the content of the event (e.g., data indicating whether the luminance value has changed from the reference value to the positive side or negative side). The event data output from the event detection unit 22 will be also referred to as event raw data as appropriate.

The additional information generation unit 23 generates various types of additional information that are added to the event data on the basis of the event data output from the event detection unit 22 and supplies the data to the data transmission unit 24. For example, the additional information generation unit 23 can generate, as additional information, frame information, line information, and pixel information as will be described in addition to the embedded data specified by CSI-2.

The data transmission unit 24 transmits the event data output from the event detection unit 22 and the additional information supplied by the additional information generation unit 23 to the data processing device 13 in a frame structure conforming to the standard of the data bus 14.

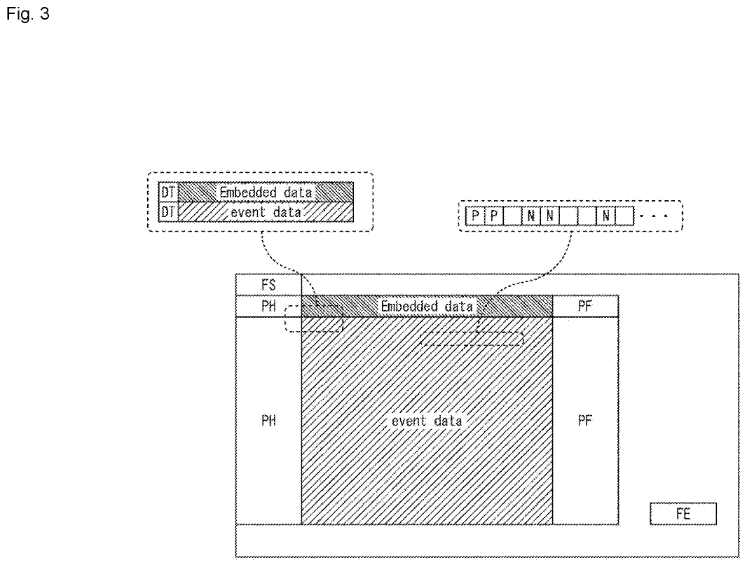

FIG. 3 illustrates an exemplary frame configuration of event data for one frame transmitted from the EVS 12 to the data processing device 13.

As shown in FIG. 3, the event data for one frame is stored in multiple long packets arranged in a line between the frame start FS, which is a short packet indicating the start of the frame, and the frame end FE, which is a short packet indicating the end of the frame. In the example shown in FIG. 3, the long packet including the embedded data placed at the start of the long packet including the event data.

The long packet has a packet header PH and a packet footer PF. A data type DT, which indicates the type of data stored in the long packet, is placed in the packet header PH, and whether embedded data or event data is stored can be distinguished according to the data type DT. In addition to placing the data type DT in the packet header PH, the data type may also be placed at the beginning of the region where data is stored in the long packet.

For example, as event data, event polarity information, which is data indicating positive P for a pixel whose luminance values have changed from the reference value to the positive side and negative N for a pixel whose luminance value has changed from the preference value to the negative side, can be used. Data other than the event polarity information may be used as the event data.

The placement position of the embedded data is not limited to the beginning of the event data as shown in FIG. 3. The frame structure may be such that multiple pieces of embedded data are placed.

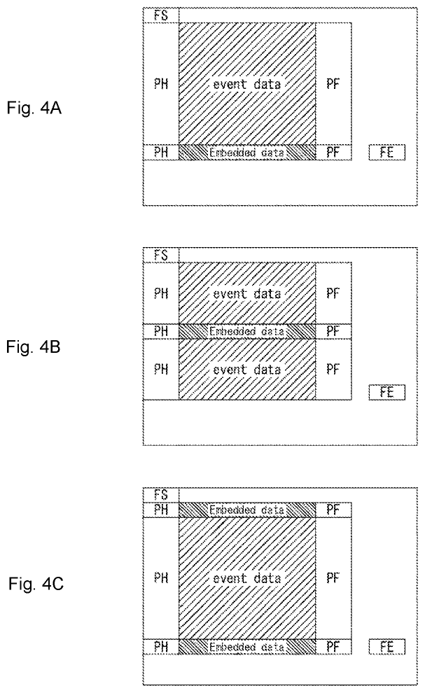

For example, the embedded data may be inserted at the end of the event data, as shown in FIG. 4 at A, or in the middle of the event data, as shown in FIG. 4 at B.

In the frame structure as shown in FIG. 4 at C, the embedded data may be placed both at the beginning and the end of the event data. For example, if information determined at the time the event is acquired, such as a time stamp or the number of frames, s used as embedded data, the embedded data is preferably placed at the beginning of the event data. Meanwhile, if information that requires prescribed calculation after the event is acquired is used as embedded data, such as information related to flicker, optical flow, and thresholds, the embedded data is preferably placed at the end of the event data.

In addition to transmitting a single piece of event data corresponding to one piece of image data as one frame, multiple pieces of event data corresponding to multiple pieces of image data may be concatenated and transmitted as one frame.

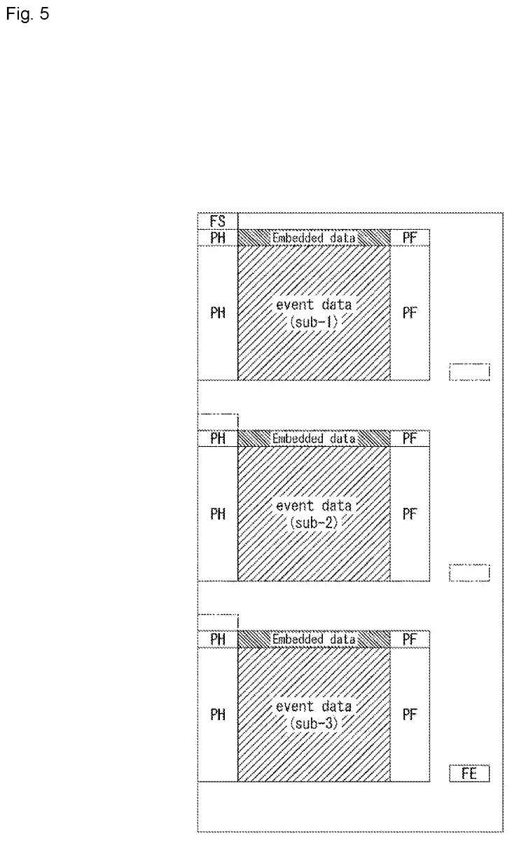

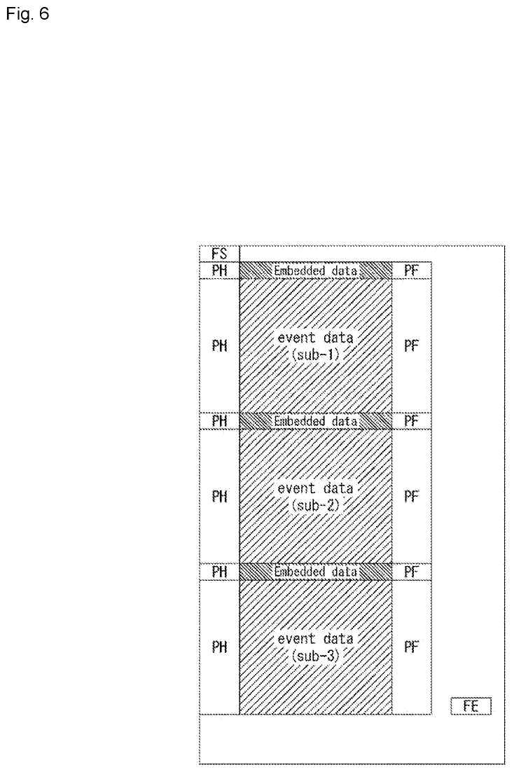

Referring to FIGS. 5 and 6, the frame structure in which pieces of event data for three frames corresponding to three images are concatenated as subframes and transmitted as a single frame will be described.

In the frame structure shown in FIG. 5, the frame end FE of the subframe to be the first event data, the frame start FS and frame end FE of the subframe to be the second event data, and the frame start FS of the subframe to be the third event data are prevented from being recognized, so that the subframes may be configured as one frame. More specifically, the subframes may be recognized as one frame by making sure that only the frame start FS of the subframe to the first event data and the frame end FE of the subframe to be the third event data are recognized, so that the event data transmitted therebetween is considered to be one frame if these subframes are not actually concatenated.

In the frame structure shown in FIG. 6, one frame is configured by actually concatenating a subframe to be the first event data, a subframe to be the second event data, and a subframe to be the third event data. There may be gaps between the subframes.

For example, the data receiving unit 31 may include an internal counter and count the number of subframes, so that multiple subframes can be recognized as a single frame and event data can be received.

### <First Exemplary Configuration of Additional Information Generation Unit>

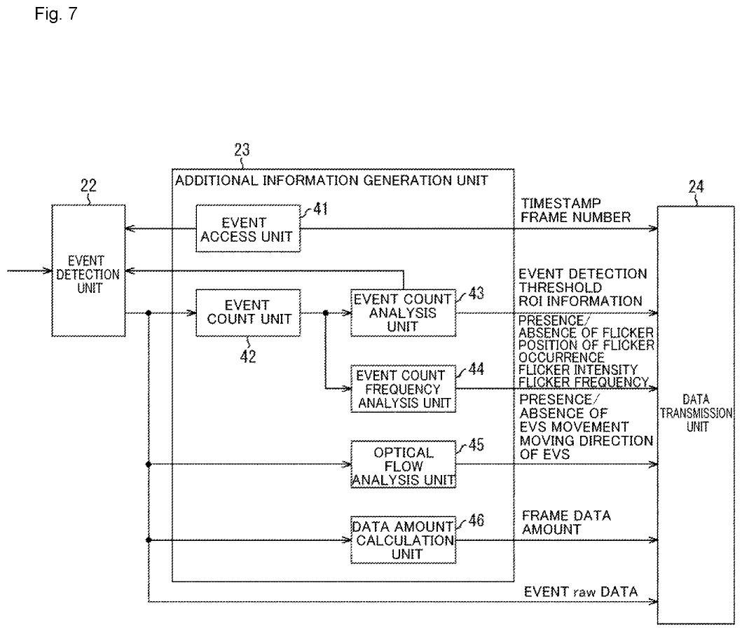

FIG. 7 is a block diagram of a first exemplary configuration of the additional information generation unit 23.

The additional information generation unit 23 shown in FIG. 7 generates frame information to be added to a frame as additional information to be additionally provided for event data. For example, the frame information is data that needs only to be acquired once in a prescribed period of time when the minimum resolution is one frame or more.

For example, the additional information generation unit 23 generates information on the frame information itself, threshold information, flicker information, movement information, and ROI (Region of Interest) information as the frame information. In addition, various setting values, event polarity, and information indicating the type of data (including possibilities other than an event) may also be used as the frame information.

The information on the frame information itself includes a time stamp indicating the time when the frame was generated, a frame number indicating the frame's position, and the amount of frame data indicating the amount of data that makes up the frame. Event detection thresholds (such as the positive and negative event detection thresholds as described above), which are thresholds for detecting an event occurrence, are used as the threshold information. The flicker information uses information indicating the presence or absence of flicker, the location of the flicker occurrence, the intensity of the flicker, and the frequency of the flicker. The movement information may be information indicating the presence/absence of the movement of the EVS 12 and the moving direction thereof. The ROI information indicates a target region in which an event has been detected.

The additional information generation unit 23 includes an event access unit 41, an event count unit 42, an event count analysis unit 43, an event count frequency analysis unit 44, an optical flow analysis unit 45, and a data amount calculation unit 46.

The event access unit 41 generates a time stamp and a frame number and supplies them to the data transmission unit 24. The event access unit 41 also instructs the event detection unit 22 about timing to scan for event data.

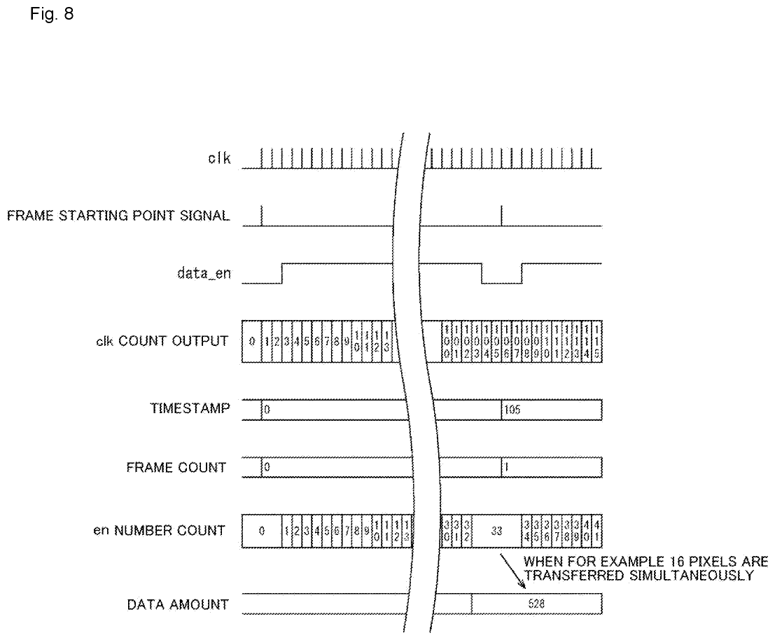

For example, the event access unit 41 has a circuit for counting the clock signal clk as shown in FIG. 8 and can then operate in response to an internal timer upon receiving an external instruction. For example, the event access unit 41 generates a time stamp for the clk count output at the timing when the frame starting point signal, which indicates the frame starting point to the event detection unit 22, is turned on. The event access unit 41 also generates a frame count obtained by counting up at the timing when the time stamp is generated as a frame number.

The event count unit 42 counts the number of times an event has occurred on the basis of event raw data supplied from the event detection unit 22 and supplies the event count indicating the count value to the event count analysis unit 43 and the event count frequency analysis unit 44.

The event count analysis unit 43 analyzes the event count supplied from the event count unit 42 to set event detection thresholds and generate ROI information and supplies the event detection thresholds and the ROI information to the data transmission unit 24.

For example, if the event count is too large, the event count analysis unit 43 determines that the current event detection threshold is set too low and sets the event detection threshold to a higher value so that events occur at appropriate frequency. Meanwhile, if the event count is too small, the event count analysis unit 43 determines that the current event detection threshold is set too high and sets the event detection threshold to a lower value so that events occur at appropriate frequency. The event count analysis unit 43 can then feed back the event detection threshold to the event detection unit 22 to adjust the frequency at which events are detected. The event detection threshold is usually set externally from the EVS 12 but can be set adaptively within the EVS 12 by the event count analysis unit 43, and the event detection threshold set in the event count analysis unit 43 must be output externally.

The event count frequency analysis unit 44 obtains flicker information indicating the presence or absence of flicker, the location of flicker occurrence, the flicker intensity, and the flicker frequency by analyzing the frequency of the event count supplied by the event count unit 42 and supplies the information to the data transmission unit 24. For example, the flicker information represents information on the flicker light source present on the screen.

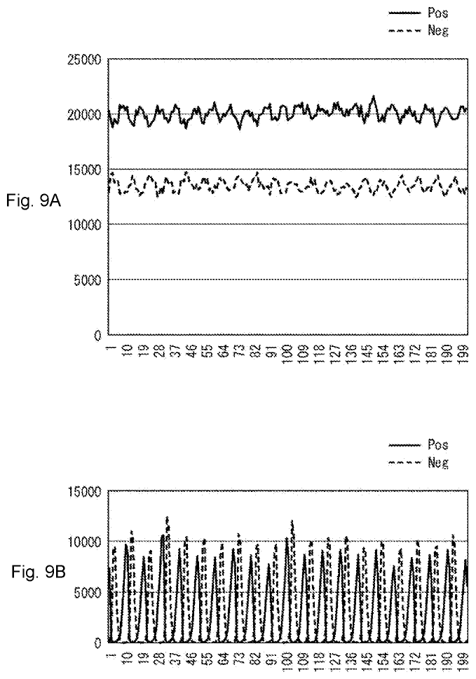

For example, FIG. 9 at A illustrates an example of event data sampling with no flicker occurrence, and FIG. 9 at B illustrates an example of event data sampling with flicker occurrence. For example, if flicker occurrence is attributable to the flickering of a light source, positive and negative event data will be biased by the flickering. In this way, since flicker appears as an event count, the flicker information can be obtained by the event count unit 42 and the event count frequency analysis unit 44.

The optical flow analysis unit 45 performs optical flow analysis on the basis of the event raw data supplied from the event detection unit 22 to analyze motion from the luminance information in the image and obtain the motion of the object by the velocity vector. As a result, the optical flow analysis unit 45 obtains information indicating whether the EVS 12 has moved and the direction of movement and supplies the information to the data transmission unit 24.

The data amount calculation unit 46 calculates the frame data amount, which is the amount of data per frame, on the basis of the event raw data supplied from the event detection unit 22 and supplies the result to the data transmission unit 24.

For example, as shown in FIG. 8, the data amount calculation unit 46 can calculate a frame data amount on the basis of an en number count value, which is a result of counting the clock signal clk during the period in which a data enable signal data_en is on. When event data about multiple pixels is transferred simultaneously, the en number count value can be multiplied by the number of pixels. When the en number count value is 33 and event data about 16 pixels is transferred simultaneously, the frame data amount results in 528.

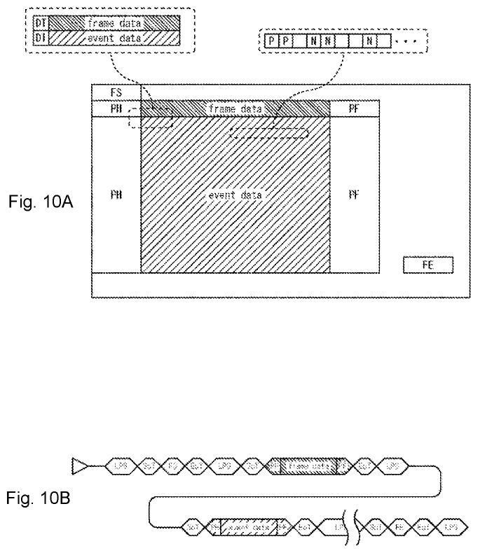

In this way, the additional information generation unit 23 can supply the time stamp, the frame number, the event detection thresholds, the ROI information, the flicker information, the information indicating whether the EVS 12 has moved and the direction of movement, and the frame data amount to the data transmission unit 24. The data transmission unit 24 can then store these kinds of information as frame information in a frame structure as shown in FIG. 10 at A and transmit these kinds of information along with the event data to the data processing device 13 via the data bus 14. FIG. 10 at B illustrates an example of the output format f frame information and event data output according to the CSI-2 standard.

More specifically, the data transmission unit 24 can store the frame information according to the location of the embedded data in the frame structure described with reference to FIG. 3. For example, the frame information may be included as part of the embedded data. The frame information may be inserted at the end or in the middle of the event data as in the embedded data shown in FIG. 4 above, or the frame information may be placed both at the beginning and at the end of the event data. Also, as described with reference to FIGS. 5 and 6, when multiple pieces of event data are concatenated to form a single frame, the frame information can be stored in the same manner as the embedded data in each subframe.

The EVS 12 that includes the additional information generation unit 23 as described above can adopt the frame structure that stores frame information in the same way as embedded data and can transmit the frame information in an output format according to the frame structure. In other words, the EVS 12 transmits the frame information as part of the embedded data and event data as part of payload data in a frame structure. This can enhance the versatility of the EVS 12.

### <Exemplary Configuration of Data Processing Device>

FIG. 11 is a block diagram of an exemplary configuration of the data processing device 13.

As shown in FIG. 1, the data processing device 13 includes the data receiving unit 31 and the event-related data processing unit 32.

The data receiving unit 31 receives frame information and event raw data in a frame structure as shown in FIG. 10 transmitted from the data transmission unit 24. The data receiving unit 31 supplies directly the event raw data to the event-related data processing unit 32 and also extracts various kinds of information included in the frame information and supplies the extracted information to the event-related data processing unit 32. In other words, the event-related data processing unit 32 receives a timestamp, the number of frames, event detection thresholds, ROI information, flicker information, information indicating whether the EVS 12 has moved and the direction of movement, and the amount of frame data from the data receiving unit 31.

The event-related data processing unit 32 can perform various kinds of data processing related to the event detected by the event detection unit 22 on the event raw data supplied by the data receiving unit 31 by referring to the various kinds of information included in the frame information.

As shown, the event-related data processing unit 32 includes an ROI arithmetic processing unit 61, a Recognition processing unit 62, an AE/AF processing unit 63, a VLC processing unit 64, an SLAM processing unit 65, an OIE/EIS processing unit 66, a MotionDetect processing unit 67, a Gesture processing unit 68, a Deblur processing unit 69, and a 3DNR processing unit 70. The various kinds of processing described here are only examples, and the event-related data processing unit 32 can perform various other kinds of processing than those described here on the basis of the event raw data.

The ROI arithmetic processing unit 61, for example, performs ROI processing to obtain coordinate information about a region to be acquired and outputs the coordinate information about that region.

The Recognition processing unit 62, for example, performs recognition processing to recognize a target object attributable to the event, and outputs the recognition result and coordinate information about the object.

The AE/AF (Auto Exposure/Auto Focus) processing unit 63 outputs distance information indicating the distance to the object attributable to the event, which is required in AE/AF processing to automatically expose or focus on the target attributable to the event.

The VLC processing unit 64 performs VLC processing to obtain distance information indicating the distance to the target.

The SLAM (Simultaneous Localization and Mapping) processing unit 65 outputs movement amount information indicating the movement amount of the EVS 12 per unit time by SLAM processing, which simultaneously estimates the self-position and creates an environmental map.

The OIS/EIS (Optical Image Stabilization/Electronic Image Stabilizer) processing unit 66 obtains and outputs the movement amount information indicating the amount of movement of the EVS 12 per unit obtained in OIE/EIS processing, which performs optical image stabilization or electronic image stabilization.

The MotionDetect processing unit 67 performs MotionDetect processing to detect the presence or absence of a moving subject in the screen and outputs information indicating the presence or absence of a moving subject.

The Gesture processing unit 68 performs Gesture processing to detect specific motions performed by a subject and outputs information indicating the detection results (such as hand waving and hand raising).

The Deblur processing unit 69 outputs information indicating the amount of movement of the subject per unit time, which is obtained in the Deblur processing to eliminate blurring of the subject.

The 3DNR processing unit 70 outputs coordinate information indicating the coordinates of a moving subject, which are obtained in 3DNR processing that removes three-dimensional noise from the subject.

### <Modification of First Exemplary Configuration of Additional Information Generation Unit>

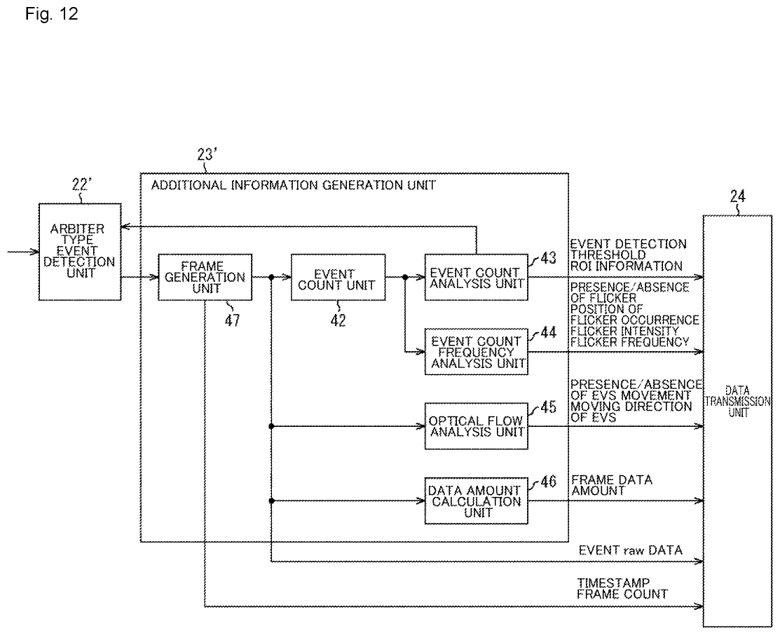

FIG. 12 is a block diagram of a modification of the first exemplary configuration of the additional information generation unit 23. In the additional information generation unit 23′ shown in FIG. 12, the same elements as those of the additional information generation unit 23 in FIG. 7 are designated by the same reference characters and detailed descriptions thereof will not be provided.

For example, the event detection unit 22 and the additional information generation unit 23 shown in FIG. 7 are scan type devices, and one frame is formed by outputting event data regardless of the presence or absence of event occurrence. In contrast, the additional information generation unit 23′ is configured to correspond to an arbiter type event detection unit 22′, which outputs event data only at the timing when an event occurs.

As shown, the additional information generation unit 23′ includes a frame generation unit 47, which is different from the additional information generation unit 23 in FIG. 7.

The frame generation unit 47 generates event data for one frame from event data output from the arbiter type event detection unit 22′ by supplementing event data at the timing when no event has occurred, and then the event data is supplied to the event count unit 42, the optical flow analysis unit 45, and the data amount calculation unit 46. The frame generation unit 47 supplies event raw data to the data transmission unit 24 and also supplies the time stamp and the frame number of the generated frame to the data transmission unit 24.

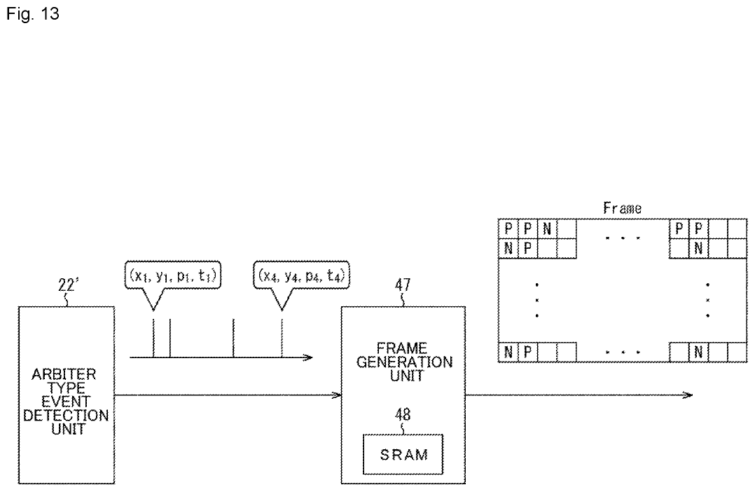

The processing carried out by the frame generation unit 47 will be described with reference to FIG. 13.

For example, when the n-th event occurs, the arbiter type event detection unit 22′ outputs the n-th event data (xₙ, yₙ, pₙ, tₙ) indicating the coordinate information and time information at that timing. The frame generation unit 47 can temporarily hold event data that has occurred during a certain one-frame period in an SRAM (Static Random Access Memory) 48 according to the coordinate information. Then, when event data that has occurred during that one-frame period is held in the SRAM, the frame generation unit 47 can output those pieces of event data in the form of frame.

In other words, since the arbiter type event detection unit 22′ does not output event data in the concept of a frame, the arbiter type the EVS 12 must include the frame generation unit 47.

### <Second Exemplary Configuration of Additional Information Generation Unit>

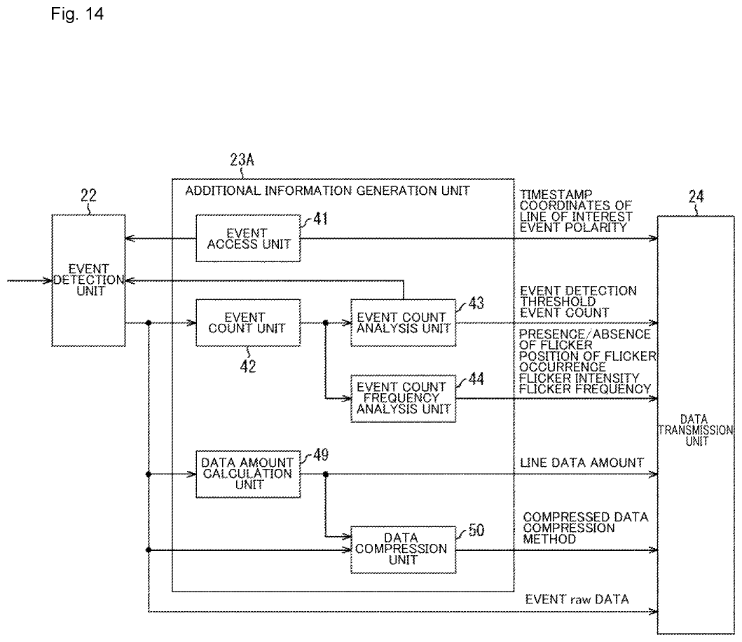

FIG. 14 is a block diagram of a second exemplary configuration of the additional information generation unit 23. In the additional information generation unit 23A shown in FIG. 14, the same elements as those of the additional information generation unit 23 in FIG. 7 are designated by the same reference characters, and detailed descriptions of thereof will not be provided.

The additional information generation unit 23A shown in FIG. 14 generates line information to be added to a line as additional information to be added to event data.

For example, the additional information generation unit 23A generates, as the line information, information about the line information itself, the identification information about the line, and flicker information.

The information about the line information itself includes the amount of data (length) of the line information itself and an identifier used to identify the information as line information. The identification information about the line information includes a time stamp, the coordinates (position) of the line, the data amount (length) of the line, the event count (activation rate/attention level) of the line, event detection thresholds of the line, the event polarity of the line, the type of data (including possible types other than events), a compression method, and other kinds of information. The flicker information includes information indicating the presence or absence of flicker on the line, the location of flicker on the line if any, the intensity of flicker on the line, and the frequency of flicker on the line.

The information about the line information itself can be provided by the data transmission unit 24. Some of these kinds of information may also be stored in embedded data. The line may be one line or multiple lines. For example, line information given every 10 lines is inserted as line information about the first line among the 10 lines.

The additional information generation unit 23A includes an event access unit 41, an event count unit 42, an event count analysis unit 43, and an event count frequency analysis unit 44, which is similar to the additional information generation unit 23 in FIG. 7. The additional information generation unit 23A includes a data amount calculation unit 49 and a data compression unit 50, which is different from the additional information generation unit 23 in FIG. 7.

The event access unit 41 generates the time stamp, the coordinates of the line, and the event polarity of the line and supplies these results to the data transmission unit 24.

The event count analysis unit 43 obtains the event count of the line, sets event detection thresholds for the line, and supplies the event detection thresholds for the line and the event count of the line to the data transmission unit 24.

The event count frequency analysis unit 44 obtains flicker information about the line indicating the presence or absence of flicker on the line, the position of flicker on the line, the intensity of flicker on the line, and the frequency of flicker on the line, and supplies the information to the data transmission unit 24.

The data amount calculation unit 49 calculates the line data amount which is the data amount of the line to be processed on the basis of event raw data supplied from the event detection unit 22 and supplies the result to the data transmission unit 24 and the data compression unit 50.

The data compression unit 50 performs data compression processing to compress the event raw data supplied from the event detection unit 22 using a pre-set compression method and supplies the compressed data obtained as a result of the processing together with the compression method to the data transmission unit 24.

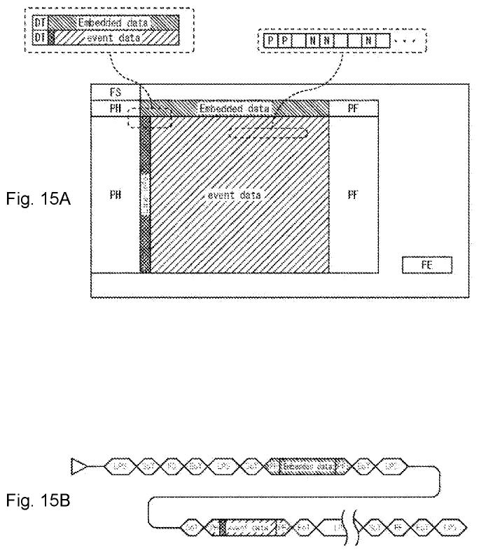

In this way, the additional information generation unit 23A can supply the time stamp, the coordinates of the line, the event polarity of the line, the event detection thresholds for the line, the event count of the line, the flicker information about the line, the amount of line data of the line, the compressed data, and the compression method to the data transmission unit 24. The data transmission unit 24 can then store these kinds of information as line information in a frame structure as shown in FIG. 15 at A and transmit the information along with the event data to the data processing device 13 via the data bus 14. FIG. 15 at B illustrates an example of the line information and event data output according to the CSI-2 standard.

In other words, as shown in FIG. 15, the data transmission unit 24 stores the line information at the beginning of the region for storing data (i.e., immediately after the packet header PH) in a long packet that stores event data for each line.

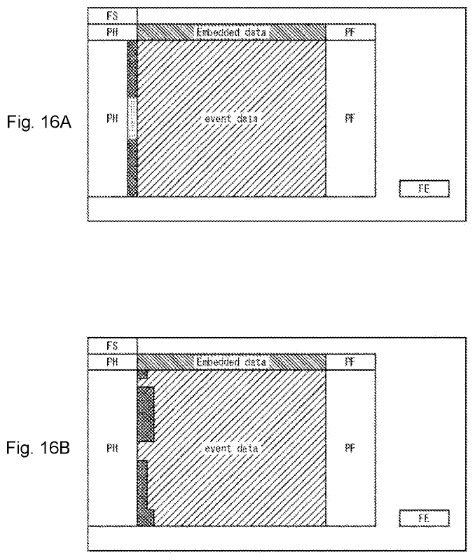

As shown in FIG. 16 at A, the line information may be included in the packet header PH. As shown in FIG. 16 at B, the data length of the line information is arbitrary.

In this way, the insertion position and number of times the line information is inserted are arbitrary, but the line information is preferably placed at the beginning of the line in consideration of actual use. In other words, if the line information is to be used to identify event data, transmitting the line information before the event data can improve the efficiency of event data processing on the side of the data processing device 13. Furthermore, by transmitting the line information before the event data, the data processing device 13 can handle the event data output from the EVS 12 while maintaining compatibility with the conventional standard.

The EVS 12 that includes the additional information generation unit 23A described above can adopt a frame structure in which line information is stored at a prescribed position in the line and can transmit the line information in an output format according to the frame structure. In other words, the EVS 12 transmits in a frame structure in which the frame information is stored at the beginning of payload data and the event data is a part of the payload data. This can enhance the versatility of the EVS 12.

The data processing device 13 can then interpret the packet header PH and the line information and determine the processing to be performed on the event data on the basis of the content described in the line information.

### <Modification of Second Exemplary Configuration of Additional Information Generation Unit>

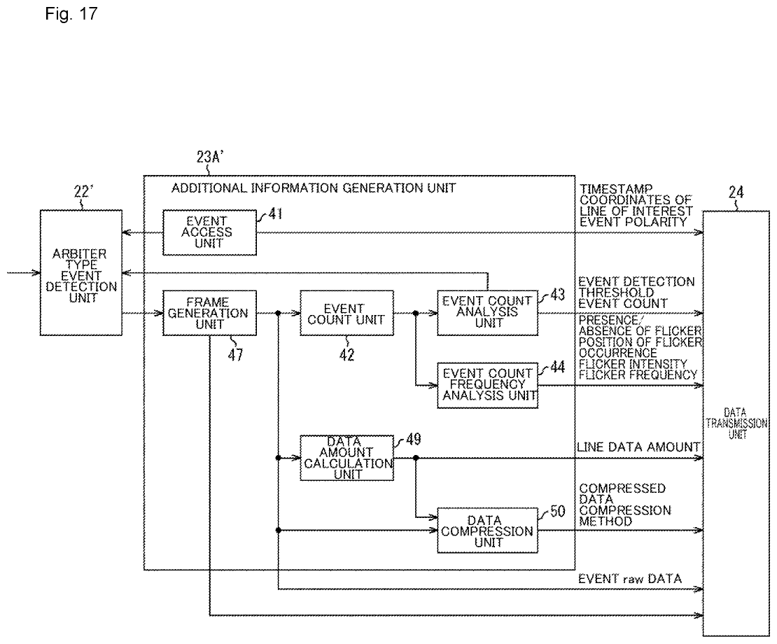

FIG. 17 is a block diagram of a modification of the second exemplary configuration of the additional information generation unit 23. In the additional information generation unit 23A′ shown in FIG. 17, the same elements as those of the additional information generation unit 23A in FIG. 14 are designated by the same reference characters and detailed descriptions thereof will not be provided.

For example, the event detection unit 22 and the additional information generation unit 23A shown in FIG. 14 above are scan type, and one frame is formed by outputting event data regardless of the presence/absence of an event occurrence. In contrast, the additional information generation unit 23A′ is configured to correspond to the arbiter type event detection unit 22′ which outputs event data only at the timing when an event occurs.

As shown, the additional information generation unit 23A′ includes a frame generation unit 47, which is different from the additional information generation unit 23A in FIG. 14. As described above with reference to FIG. 13, the frame generation unit 47 can temporarily hold event data that has occurred during a certain one-frame period in the SRAM 48 and output event data that has occurred during the one-frame period in the form of a frame.

### <Third Exemplary Configuration of Additional Information Generation Unit>

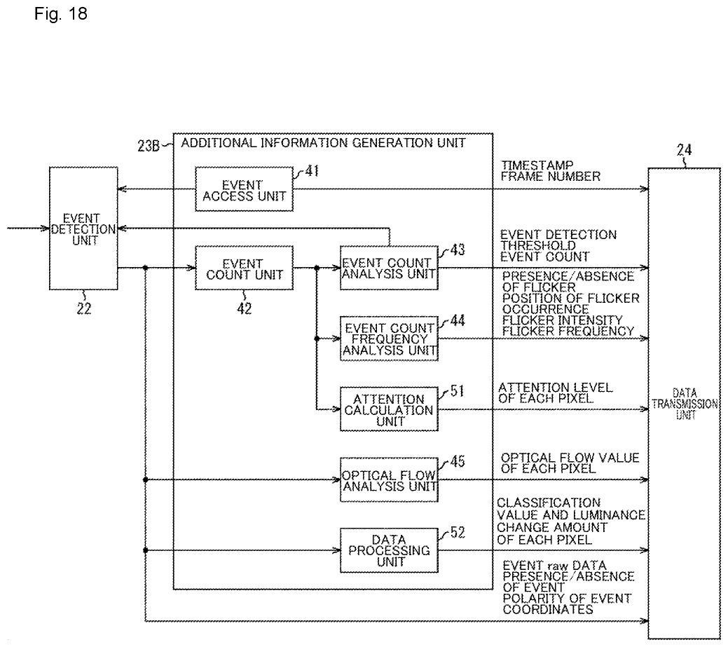

FIG. 18 is a block diagram of a third exemplary configuration of the additional information generation unit 23. In the additional information generation unit 23B shown in FIG. 18, the same elements as those of the additional information generation unit 23 in FIG. 7 are designated by the same reference characters and detailed descriptions of thereof will not be provided.

The additional information generation unit 23B shown in FIG. 18 generates pixel information to be added to pixels as additional information to be added to event data.

For example, the additional information generation unit 23B generates event information, flicker information, and information obtained from event information as pixel information.

The event information includes a time stamp, coordinates, the presence or absence of an event, the polarity of the event that has occurred, event detection thresholds, an amount of luminance change, and an event count (activation rate). The flicker information may be information indicating the presence or absence of flicker, the location of flicker if any, the intensity of flicker, and the frequency of flicker. The information obtained from the event information is information given to a region across one or more pixels by operations on the basis of the event information about pixels and may be information indicating an optical flow, an attention level, or a classification value.

Similarly to the additional information generation unit 23 in FIG. 7, the additional information generation unit 23B includes an event access unit 41, an event count unit 42, an event count analysis unit 43, an event count frequency analysis unit 44, and an optical flow analysis unit 45. The additional information generation unit 23B includes an attention calculation unit 51 and a data processing unit 52, which is different from the additional information generation unit 23 in FIG. 7.

The optical flow analysis unit 45 determines the optical flow value of each pixel on the basis of event raw data supplied from the event detection unit 22 and supplies the optical flow value to the data transmission unit 24.

The attention calculation unit 51 calculates the attention level of each pixel on the basis of an event count supplied by the event count unit 42 and supplies the result to the data transmission unit 24.

The data processing unit 52 may include a neural network and perform data processing using machine learning based on event raw data supplied from the event detection unit 22 to calculate the classification value and the amount of luminance change in each pixel and supplies the result to the data transmission unit 24.

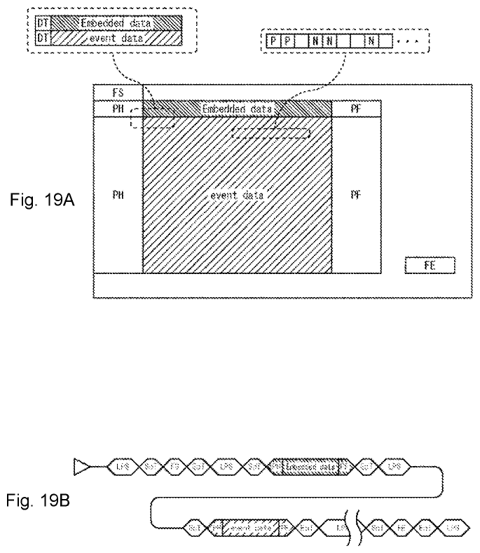

In this way, the additional information generation unit 23B can supply the time stamp, the number of frames, event detection thresholds, the event count, the flicker information, the attention level of each pixel, the optical flow value of each pixel, the amount of luminance change, the presence or absence of an event, and the polarity of the event if any to the data transmission unit 24. The data transmission unit 24 can then embed these kinds of information as pixel information in the data of each pixel, together with the event data, and store them in a frame structure as shown in FIG. 19 at A. FIG. 19 at B illustrates an example of event data (data with pixel information embedded in each pixel) output according to the CSI-2 standard.

The data transmission unit 24 can insert, in the data type DT, mode information which indicates how many bits of data are used in the data for one pixel depending on the data amount of pixel information to be embedded in the data of the pixel. For example, if the mode information indicates mode 1, the amount of data for a pixel is 2 bits for 0/−/+, and if the mode information indicates mode 2, the amount of data for a pixel is 2 bits for 0/−/+ plus a required data amount a. This allows the output of the EVS 12 to be changed flexibly according to the use of the application and the amount or accuracy of information required.

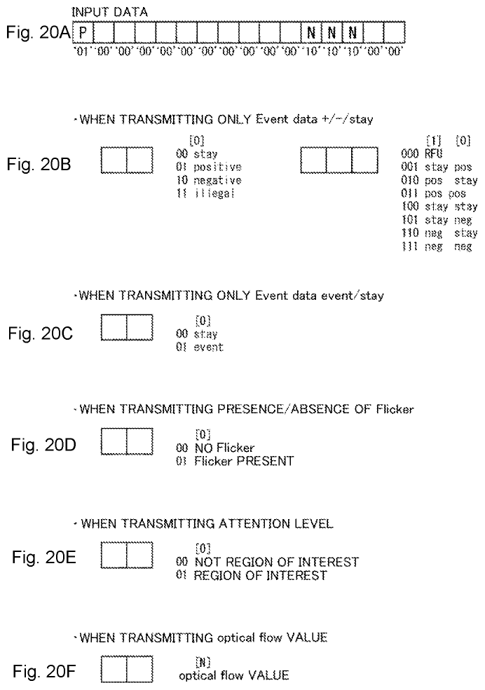

With reference to FIG. 20 at A, a method for transmitting pixel information embedded in pixel data will be described.

FIG. 20 at A illustrates an example of input data input from the event detection unit 22 to the additional information generation unit 23B. For example, “01” is input for positive event data, “10” for negative event data, and “00” for stay event data with no luminance change.

FIG. 20 at B illustrates an example of data when only event data (+/−/stay) is transmitted using 2 or 3 bits.

For example, when transmitting only event data (+/−/stay) using 2 bits, “01” is input for positive event data, “10” for negative event data, and “00” for stay event data. When transmitting only event data (+/−/stay) using 3 bits, “001” is input for stay-positive event data, “010” for positive-stay event data, “011” for positive-positive event data, “100” stay-stay event data, “101” for stay-negative event data, “110” for negative-stay event data, and 111 for negative-negative event data.

FIG. 20 at C illustrates an example of data when only event data (event/stay) is transmitted using 2 bits. For example, “00” is input for stay event data, and “01” for the event data indicating the occurrence of an event.

FIG. 20 at D illustrates an example of data when pixel information indicating the presence or absence of flicker is transmitted using 2 bits. For example, “00” is input for pixel information indicating no flicker, and “01” is input for pixel information indicating flicker.

FIG. 20 at E illustrates an example of data when the pixel information indicating a level of attention is transmitted using 2 bits. For example, “00” is input for pixel information indicating that the region is not a region of interest, and “01” is input for pixel information indicating that the region is a region of interest.

FIG. 20 at F illustrates an example of data when pixel information indicating an optical flow value is transmitted using 2 bits.

In this way, the EVS 12 can select between transmission of only event data and transmission of event data with pixel information. In addition, the selection (of data length and content selection) can be fixed for example by a Fuse or a ROM or can be dynamically made on a frame-basis. When the selection is dynamically made on a frame-basis, for example, frame information stored in embedded data can be used.

The EVS 12 that includes the additional information generation unit 23B configured as described above can adopt a frame structure in which pixel information is embedded for event data and can transmit the pixel information in an output format according to the frame structure. This can enhance the versatility of the EVS 12.

The data processing device 13 may include a circuit that determines, on the basis of data acquired from the EVS 12, the presence/absence of mode switching, i.e., how many bits are used in the data for one pixel and generates a switching instruction signal to be transmitted to the EVS 12.

### <Modification of Second Exemplary Configuration of Additional Information Generation Unit>

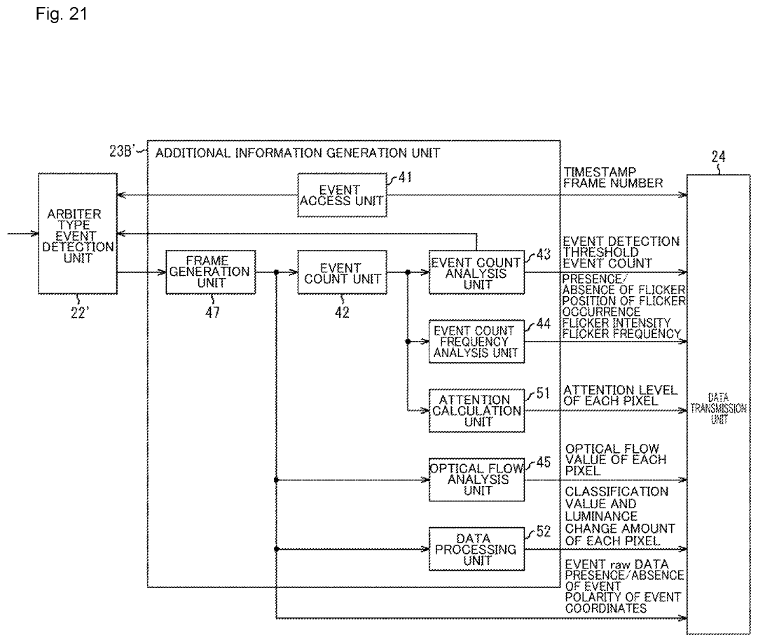

FIG. 21 is a block diagram of a modification of the second exemplary configuration of the additional information generation unit 23. In the additional information generation unit 23B′ shown in FIG. 21, the same elements as those of the additional information generation unit 23B in FIG. 18 are designated by the same reference characters, and detailed descriptions of thereof will not be provided.

For example, the event detection unit 22 and the additional information generation unit 23B shown in FIG. 18 are scan type devices, and one frame is formed by outputting event data regardless of the presence/absence of event occurrence. In contrast, the additional information generation unit 23B′ is configured to correspond to an arbiter type event detection unit 22′, which outputs event data only at the timing when an event occurs.

As shown, the additional information generation unit 23B′ includes a frame generation unit 47, which is different from the additional information generation unit 23B in FIG. 18. As described above with reference to FIG. 13, the frame generation unit 47 can temporarily hold data on an event that has occurred during a certain one-frame period in the SRAM 48 and output the data on the event that has occurred during that one-frame period in the form of a frame.

### <Multiple Physical Layer Switching Configurations>

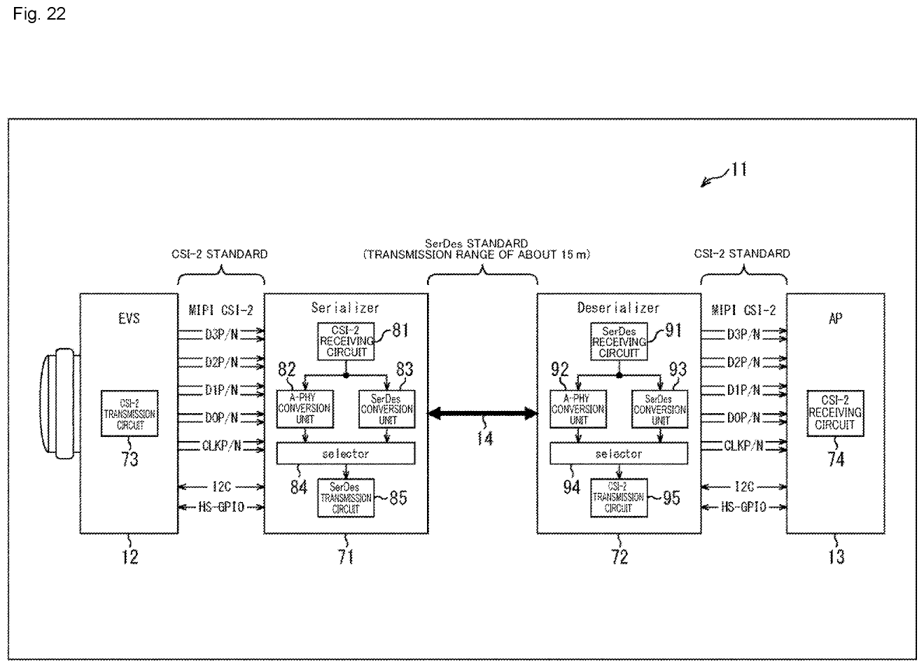

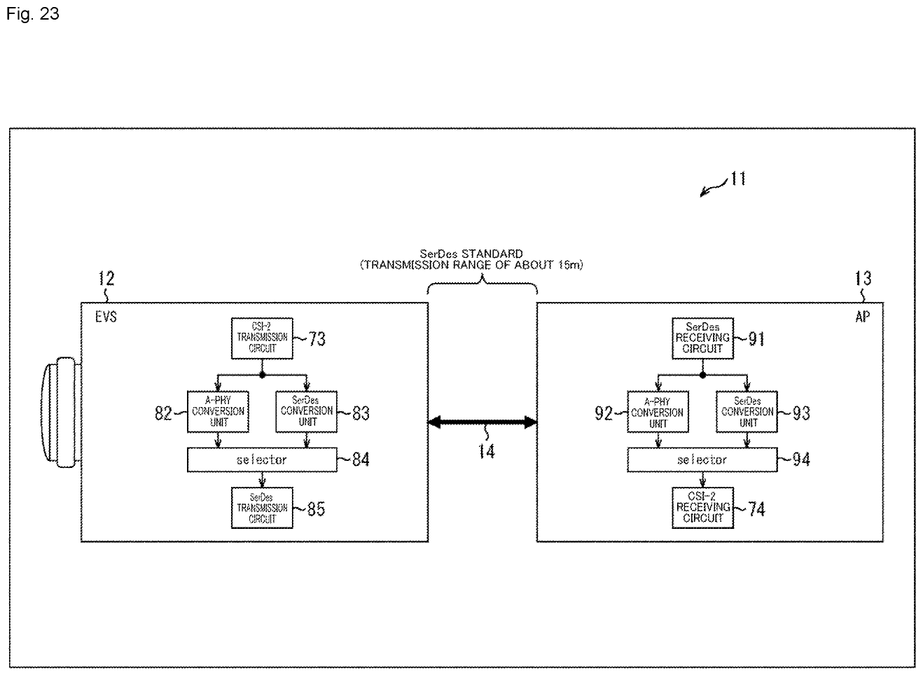

With reference to FIGS. 22 and 23, an exemplary configuration of a sensor system 11 that can switch between multiple physical layers will be described.

For example, the sensor system 11 can use A-PHY, a SerDes standard for connecting devices in a vehicle with a transmission distance of about 15 meters, as a physical layer for transmitting data between the EVS 12 and the data processing device 13. The sensor system 11 can also use physical layers other than A-PHY (e.g., C-PHY and D-PHY) and is configured to switch between these physical layers.

FIG. 22 illustrates an exemplary configuration of the sensor system 11 capable of switching the physical layer between a serializer and a de-serializer.

As shown in FIG. 22, the sensor system 11 includes a serializer 71 and a de-serializer 72. The sensor system 11 is configured so that communication between the EVS 12 and the serializer 71 and between the data processing device 13 and the de-serializer 72, respectively is performed according to the CSI-2 standard, and communication between the serializer 71 and the de-serializer 72 is performed via the data bus 14.

The EVS 12 includes a CSI-2 transmission circuit 73 corresponding to the data transmission unit 24 in FIG. 1, and the data processing device 13 includes a CSI-2 receiving circuit 74 corresponding to the data receiving unit 31 in FIG. 1.

The serializer 71 includes a CSI-2 receiving circuit 81, an A-PHY conversion unit 82, a SerDes conversion unit 83, a selector 84, and a SerDes transmission circuit 85.

In the serializer 71, the CSI-2 receiving circuit 81 receives event data transmitted from the CSI-2 transmission circuit 73 of the EVS 12 and supplies the data to the A-PHY conversion unit 82 and the SerDes conversion unit 83. The A-PHY conversion unit 82 serially converts the event data supplied from the CSI-2 receiving circuit 81 according to a general SerDes standard other than A-PHY and supplies the data to the selector 84. The SerDes conversion unit 83 serially converts the event data supplied from the CSI-2 receiving circuit 81 according to the general SerDes standard other than A-PHY and supplies the result to the selector 84. The selector 84, for example, selects one of the serial-converted event data supplied from the A-PHY conversion unit 82 and the serial-converted event data supplied from the SerDes conversion unit 83 in response to a prescribed selection signal and supplies the selected data to the SerDes transmission circuit 85. The SerDes transmission circuit 85 transmits the serial-converted event data, the one selected by the selector 84, via the data bus 14.

The de-serializer 72 includes a SerDes receiving circuit 91, an A-PHY conversion unit 92, a SerDes conversion unit 93, a selector 94, and a CSI-2 transmission circuit 95.

In the de-serializer 72, the SerDes receiving circuit 91 receives event data transmitted via the data bus 14 and supplies the data to the A-PHY conversion unit 92 and the SerDes conversion unit 93. The A-PHY conversion unit 92 performs de-serial conversion to the event data supplied from the SerDes receiving circuit 91 according to the A-PHY standard and supplies the result to the selector 94. The SerDes conversion unit 93 subjects the event data supplied from the SerDes receiving circuit 91 to de-serial conversion which corresponds to the serial conversion by the SerDes conversion unit 83 and supplies the result to selector 94. The selector 94 selects, for example, one of the event data supplied from the A-PHY conversion unit 92 and the event data supplied from the SerDes conversion unit 93 in response to a prescribed selection signal and supplies the selected data to the CSI-2 transmission circuit 95. The CSI-2 transmission circuit 95 transmits the event data selected by the selector 94 to the CSI-2 receiving circuit 74 of the data processing device 13.

In this way, the sensor system 11 can switch between serial conversion according to the A-PHY standard and serial conversion according to the general SerDes standard in the serializer 71 and de-serializer 72. Switching is performed between the A-PHY conversion unit 82 and the SerDes conversion unit 83 and between the A-PHY conversion unit 92 and the SerDes conversion unit 93 so that serial conversion according to the same standard is performed in the serializer 71 and the de-serializer 72.

FIG. 23 illustrates an exemplary configuration of the sensor system 11 that includes the EVS 12 and the data processing device 13 that are capable of switching between physical layers.

As shown in FIG. 23, the EVS 12 includes a CSI-2 transmission circuit 73, an A-PHY conversion unit 82, a SerDes conversion unit 83, a selector 84, and a SerDes transmission circuit 85, while the data processing device 13 includes a CSI-2 receiving circuit 74, a SerDes receiving circuit 91, an A-PHY conversion unit 92, a SerDes conversion unit 93, and a selector 94.

In this way, the sensor system 11 can switch between serial conversion according to the A-PHY standard and serial conversion according to the general SerDes standard in the EVS 12 and the data processing device 13. Switching is performed between the A-PHY conversion unit 82 and the SerDes conversion unit 83 and between the A-PHY conversion unit 92 and the SerDes conversion unit 93 so that serial conversion according to the same standard is performed in the EVS 12 and the data processing device 13.

### <Exemplary Configuration of Electronic Device>

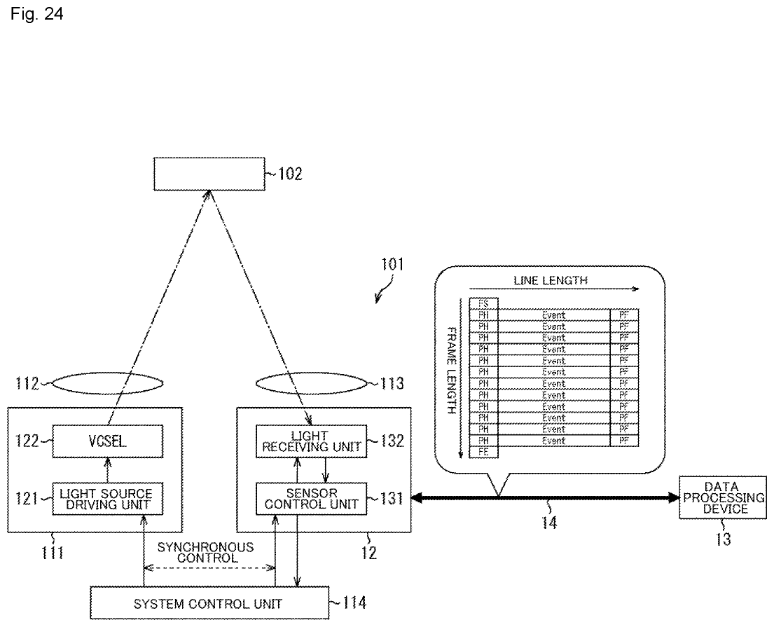

With reference to FIGS. 24 to 27, an exemplary configuration of an electronic device including the EVS 12 will be described.

FIG. 24 is a block diagram of an exemplary configuration of an electronic device 101 including the EVS 12.

As shown in FIG. 24, the electronic device 101 including the EVS 12 includes a laser source 111, an irradiation lens 112, an imaging lens 113, an EVS 12, and a system control unit 114.

As shown in FIG. 24, the laser source 111 may include a vertical cavity surface emitting laser (VCSEL) 122 and a light source driving unit 121 that drives the VCSEL 122. However, instead of the VCSEL 122, various other light sources such as an LED (Light Emitting Diode) may be used. The laser source 111 may be a point light source, a surface light source, or a line light source. In the case of a surface or line light source, the laser source 111 may include a plurality of point light sources (such as VCSELs) in a one- or two-dimensional arrangement. According to the embodiment, the laser source 111 may emit light in a wavelength band different from that of visible light, such as infrared (IR) light.

The irradiation lens 112 is placed on the emission side of the laser source 111 and converts light emitted from the laser source 111 into irradiation light with a prescribed spread angle.

The imaging lens 113 is placed on the light-receiving side of the EVS 12 and forms an image by the incident light on the light-receiving surface of the EVS 12. The incident light can include light emitted from the laser source 111 and reflected by an object 102.

As shown in FIG. 24, the EVS 12 may include a light receiving unit 132 in which pixels for detecting events (hereinafter referred to as “event pixels”) are arranged in a two-dimensional grid, and a sensor control unit 131 that generates frame data based on the event data detected at the event pixels by driving the light receiving unit 132.

The system control unit 114 may include a processor (CPU) which drives the VCSEL 122 via the light source driving unit 121. The system control unit 114 also controls the EVS 12 in synchronization with the control over the laser source 111 to obtain event data detected in response to the emission/extinction of the laser source 111.

For example, the irradiation light emitted from the laser source 111 is projected through the irradiation lens 112 onto the object 102. The projected light is reflected by the object 102. The light reflected by the object 102 passes through the imaging lens 113 and enters the EVS 12. The EVS 12 receives the light reflected by the object 102, generates event data, and generates frame data on the basis of the generated event data in the form of a single image.

The frame data generated by the EVS 12 is supplied to the data processing device 13 via the data bus 14. As shown, the frame data includes a frame header FS indicating the beginning of the frame data, a line header PH indicating the beginning of each line data, a line footer PF indicating the end of each line data, a line data Event between the line header PH and the line footer PF, and a frame footer FE which indicates the end of the frame data is output, the line data Event about all the lines of the frame data is included between the frame header FS and the frame footer FE. Each line data Event may include event data (such as a positive event, a negative event, and no event) for all pixels constituting each line, as well as a y-address indicating the position of the line, or a flag indicating whether the line data is uncompressed data or data compressed using any encoding method, which encoding method was used to compress the data or which signal processing method was used to obtain the signal processing result.

The data processing device 13 which includes for example an application processor executes prescribed processing such as image processing and recognition processing on the frame data input from the EVS 12.

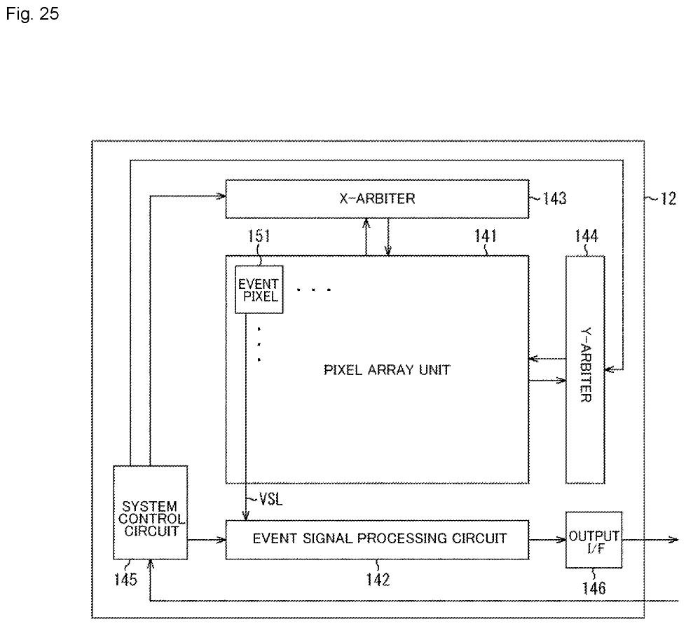

FIG. 25 is a block diagram of an overall exemplary configuration of the EVS 12.

For example, a pixel array unit 141, an X-arbiter 143, and a Y-arbiter 144 shown in FIG. 25 correspond to the luminance detection unit 21 and the arbiter type event detection unit 22′ described above. The additional information generation unit 23′ is incorporated as the function of the event signal processing circuit 142 and the system control circuit 145 shown in FIG. 25, and an output interface 146 shown in FIG. 25 corresponds to the data transmission unit 24 described above.

As shown in FIG. 25, the EVS 12 includes a pixel array unit 141, an X-arbiter 143, a Y-arbiter 144, an event signal processing circuit 142, a system control circuit 145, and an output interface (I/F) 146.

The pixel array unit 141 includes a plurality of event pixels 151 in a two-dimensional grid arrangement, and each of the pixels detects an event on the basis of a luminance change in the incident light. In the following description, the direction of rows (also referred to as the row direction) refers to the direction in which pixels are arranged in a pixel row (in the horizontal direction in the drawing), and the direction of columns (also referred to as the column direction) refers to the direction in which pixels are arranged in a pixel column (in the vertical direction in the drawing).

The event pixels 151 each have a photoelectric conversion element that generates charge according to the luminance of the incident light, output a request for reading from itself to the X-arbiter 143 and the Y-arbiter 144 upon detecting a change in the luminance of the incident light on the basis of the photocurrent that flows out from the photoelectric conversion element, and outputs an event signal indicating the occurrence of an event in response to arbitration by the X-arbiter 143 and the Y-arbiter 144.

The event pixels 151 each detect the presence or absence of an event according to whether a change exceeding a prescribed threshold has occurred in the photocurrent corresponding to the luminance of the incident light. For example, the event pixels 151 each detect, as an event, a luminance change exceeding a prescribed threshold (positive event) or falling below a prescribed threshold (negative event).

Upon detecting an event, the event pixel 151 outputs a request to the X-arbiter 143 and the Y-arbiter 144 which requests permission to output an event signal representing the occurrence of the event. Upon receiving a response from each of the X-arbiter 143 and Y-arbiter 144 indicating permission to output an event signal, the event pixel 151 outputs an event signal to the event signal processing circuit 142.

The X-arbiter 143 and the Y-arbiter 144 arbitrate a request for outputting an event signal supplied from each of the plurality of event pixels 151 and transmit a response on the basis of the result of the arbitration (permission or non-permission to output an event signal) and a reset signal to reset the event detection to the event pixel 151 that has output the request.

The event signal processing circuit 142 generates and outputs event data by performing prescribed signal processing on the event signal input from the event pixel 151.

As described above, a change in the photocurrent generated by the event pixel 151 can also be viewed as a change in the light intensity (luminance change) of light incident on the photoelectric conversion unit of event pixel 151. Therefore, an event can also be considered to be a change in the light intensity (luminance change) of the event pixel 151 that exceeds a predetermined threshold. The event data representing the occurrence of an event includes at least position information such as coordinates representing the position of the event pixel 151 where the light intensity change as an event has occurred. In addition to the position information, the event data can also include the polarity of the light intensity change.

As for a series of event data pieces output at the timing of an event occurrence from the event pixel 151, as long as the intervals between event data pieces at the time of the event occurrence are maintained unchanged, the event data should implicitly include time information representing the relative time about the event occurrence.

However, if the interval between event data pieces at the time of the event occurrence can no longer be maintained unchanged for example as the event data is stored in a memory, the time information implicitly included in the event data is lost. Therefore, the event signal processing circuit 142 may include time information representing the relative time of the event occurrence for example as a time stamp before the intervals between event data pieces at the time of the event occurrence become no longer unchanged.

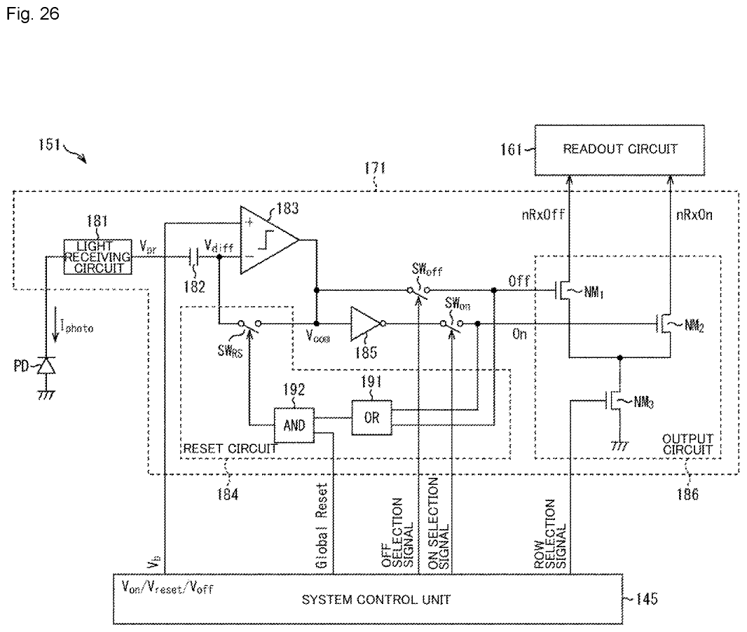

FIG. 26 is a circuit diagram of an overall exemplary configuration of the event pixel 151. FIG. 26 illustrates an exemplary configuration in which one comparator detects a positive event and a negative event in a time-division manner.

Here, the events can include a positive event indicating that the amount of change in the photocurrent exceeds an upper threshold and a negative event indicating that the amount of change is below a lower threshold. In such a case, the event data indicating the occurrence of the event can include, for example, one bit indicating the occurrence of the event and one bit indicating the polarity of the event that has occurred. The event pixel 151 can be configured to have a function to detect only positive events or only negative events.

As shown in FIG. 26, the event pixel 151 has, for example, a photoelectric conversion part PD and an address event detection circuit 171. The photoelectric conversion part PD may include a photodiode, and electric charge generated by photoelectric conversion of incident light is outflowed as a photocurrent Iₚₕₒₜₒ. The outflowed photocurrent Iₚₕₒₜₒ flows into the address event detection circuit 171.

The address event detection circuit 171 has a light receiving circuit 181, a memory capacitance 182, a comparator 183, a reset circuit 184, an inverter 185, and an output circuit 186.

The light receiving circuit 181 may include a current-to-voltage conversion circuit which converts the photocurrent Iₚₕₒₜₒ that flows out from the photoelectric conversion unit PD into a voltage Vₚᵣ. Here, the relationship of voltage Vₚᵣ to light intensity (luminance) is usually a logarithmic relationship. In other words, the light receiving circuit 181 converts the photocurrent Iₚₕₒₜₒ, which corresponds to the intensity of light emitted on the light-receiving surface of the photoelectric conversion unit PD, into the voltage Vₚᵣ, which is a logarithmic function. However, the relationship between the photocurrent Iₚₕₒₜₒ and the voltage Vₚᵣ is not limited to such a logarithmic relationship.

The voltage Vₚᵣ corresponding to the photocurrent Iₚₕₒₜₒ, which is output from the light receiving circuit 181, becomes a first inverting (−) input of the comparator 183 as voltage V_{diff} after passing through the memory capacitance 182. The comparator 183 usually includes a differential pair of transistors. The comparator 183 detects a positive event and a negative event in a time-division manner using a threshold voltage V_{b} provided by the system control circuit 145 as a second input, a non-inverting (+) input. After the positive/negative event detection, the event pixel 151 is reset by the reset circuit 184.

The system control circuit 145 outputs, in a time-division manner, a voltage Vₒₙ at the positive event detection stage, the voltage V_{off} at the negative event detection stage, and the voltage Vᵣₑₛₑₜ at the resetting stage as the threshold voltage V_{b}. The voltage Vᵣₑₛₑₜ is set to a value between the voltages Vₒₙ and V_{off}, preferably to an intermediate value between the voltages Vₒₙ and V_{off}. Here, the term “intermediate value” refers not only strictly to the intermediate value but also to substantially an intermediate value, and the existence of various variations arising in design or manufacturing is allowed.

The system control circuit 145 outputs an ON selection signal to the event pixel 151 at the stage of detecting a positive event, an OFF selection signal at the stage of detecting a negative event, and a global reset signal (Global Reset) at the stage of resetting. The ON selection signal is applied as its control signal to the selection switch SWₒₙ provided between an inverter 185 and the output circuit 186. The OFF selection signal is applied to the selection switch SW_{off} provided between the comparator 183 and the output circuit 186 as its control signal.

At the stage of detecting a positive event, the comparator 183 compares the voltage Vₒₙ and the voltage V_{diff}, and when the voltage Vₐᵢᵣ exceeds the voltage Vₒₙ, positive event information On indicating that the amount of change in photocurrent Iₚₕₒₜₒ exceeds the upper threshold is output as a comparison result. The positive event information On is inverted by the inverter 185 and then supplied to the output circuit 186 through the selection switch SWₒₙ.

At the stage of detecting a negative event, the comparator 183 compares voltage V_{off} with voltage Vₐᵢᵣ, and when voltage V_{diff} falls below voltage V_{off}, negative event information Off indicating that the change in photocurrent Iₚₕₒₜₒ is below the lower threshold is output as a comparison result. The negative event information Off is supplied to the output circuit 186 through the selection switch SW_{off}.

The reset circuit 184 has a reset switch SW_{RS}, a 2-input OR circuit 191, and a 2-input AND circuit 192. The reset switch SW_{RS} is connected between the inverting (−) input terminal and the output terminal of the comparator 183, and when turned on (closed), the switch selectively short-circuits between the inverting input terminal and the output terminal.

The OR circuit 191 takes the positive event information On through the selection switch SWₒₙ and the negative event information Off through the selection switch SW_{off} as its two inputs. The AND circuit 192 takes an output signal from the OR circuit 191 as one input and the global reset signal applied from the system control circuit 145 as the other input, and when either the positive event information On or the negative event information Off is detected and the global reset signal is in an active state, the reset switch SW_{RS} is turned on (closed).

In this way, when an output signal from the AND circuit 192 becomes active, the reset switch SW_{RS} short-circuits between the inverting input terminal of the comparator 183 and the output terminal, and global resetting is performed for the event pixel 151. As a result, the reset operation is performed only for the event pixel 151 for which an event has been detected.

The output circuit 186 has a negative event output transistor NM₁, a positive event output transistor NM₂, and a current source transistor NM₃. The negative event output transistor NM₁ has a memory (not shown) at its gate to hold negative event information Off. The memory is made of the gate parasitic capacitance of the negative event output transistor NM₁.

Similarly to the negative event output transistor NM₁, the positive event output transistor NM₂ has a memory (not shown) at its gate unit to hold positive event information On. The memory is made of the gate parasitic capacitance of the positive event output transistor NM₂.

At the reading-out stage, the negative event information Off held in the memory of the negative event output transistor NM₁ and the positive event information On held in the memory of the positive event output transistor NM₂ are transferred to a readout circuit 161 through an output line nRxOff and an output line nRxOn for each pixel row of the pixel array unit 141 in response to a row selection signal applied to the gate electrode of the current source transistor NM₃ from the system control circuit 145. The readout circuit 161 may be provided within the event signal processing circuit 142 (see FIG. 25).

As described above, the event pixel 151 has an event detection function to detect a positive event and a negative event in a time division manner under control by the system control circuit 145 using the single comparator 183.

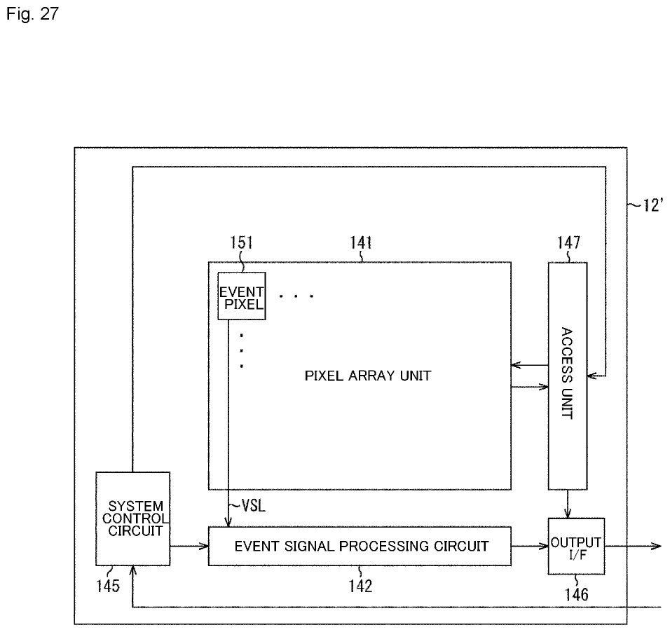

FIG. 27 illustrates an exemplary configuration of a scan type EVS 12′.

As shown in FIG. 27, the scan type EVS 12′ includes an access unit 147 instead of the X-arbiter 143 and the Y-arbiter 144 of the arbiter type EVS 12 shown in FIG. 25. In other words, the EVS 12′ includes a pixel array unit 141, an event signal processing circuit 142, a system control circuit 145, and an output interface 146, which is the same as that of the EVS 12 shown in FIG. 25.

For example, the access unit 147 corresponds to the event access unit 41 in FIG. 7 and instructs each event pixel 151 in the pixel array unit 141 about the timing to scan event data.

<Exemplary Configuration of Sensor System with Multiple Sensor>

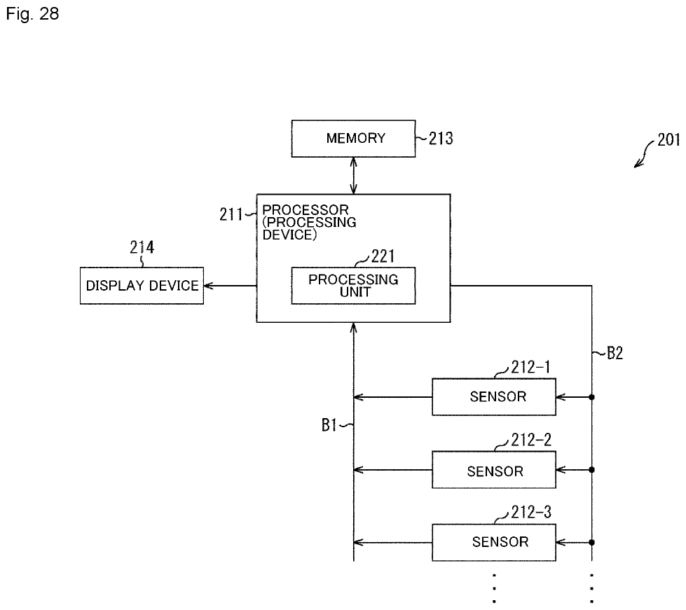

Referring to FIGS. 28 to 33, an exemplary configuration of a sensor system including multiple sensors will be described.

For example, the EVS 12 described above can be used as all or at least one of the sensors 212 shown in FIG. 28. The processor 211 shown in FIG. 28 corresponds to the data processing device 13, and the data bus B1 shown in FIG. 28 corresponds to the data bus 14.

FIG. 28 illustrates an exemplary configuration of a sensor system 201. The sensor system 201 may include a communication device such as a smartphone and a moving object such as a drone (a device capable of operating by remote control or autonomously) and an automobile. Examples of applications of the sensor system 201 are not limited to the above.

The sensor system 201 may include a processor 211, multiple sensors 212-1, 212-2, 212-3, . . . having a function to output images, a memory 213, and a display device 214. In the following, the multiple sensors 212-1, 212-2, 212-3, . . . may be referred to as “sensor 212” collectively or to represent one of the sensors 212-1, 212-2, 212-3, . . . .

FIG. 28 illustrates the sensor system 201 having three or more sensors 212, but the number of sensors 212 of the system according to the embodiment is not limited to the example shown in FIG. 28. For example, the system according to the embodiment may have two or more sensors 212 such as two sensors 212 and three sensors 212. For the ease of description, in the following examples, images are output from two among the multiple sensors 212 of the sensor system 201 or from three among the multiple sensors 212 of the sensor system 201.

The processor 211 and each of the multiple sensors 212 are electrically connected by a single data bus B1. The data bus B1 is a single signal transmission path that connects the processor 211 and each of the sensors 212. For example, data indicating an image output from each of the sensors 212 (hereinafter referred to as “image data”) is transmitted from the sensor 212 to the processor 211 via the data bus B1.

A signal is transmitted by the data bus B1 in the sensor system 201 according to an arbitrary standard, such as the CSI-2 standard and PCI Express which specifies the start and end of data to be transmitted on the basis of prescribed data. The prescribed data may include the start packet of a frame in the CSI-2 standard and the end packet of a frame in the CSI-2 standard. In the following example, signals are transmitted by the data bus B1 according to the CSI-2 standard.

The processor 211 and each of the multiple sensors 212 are electrically connected by the control bus B2 which is different from the data bus B1. The control bus B2 is a transmission path for other signals that connect the processor 211 and each of the sensors 212. For example, control information output from the processor 211 (which will be described) is transmitted from the processor 211 to the sensor 212 via the control bus B2. In the following example, signals transmitted by control bus B2 are transmitted according to the CSI-2 standard as with the data bus B1.

FIG. 28 illustrates an example in which the processor 211 and each of the multiple sensors 212 are connected by the single control bus B2, but the system according to the embodiment may also be provided with a control bus for each sensor 212. The configuration of the processor 211 and each of the multiple sensors 212 is not limited to the configuration in which control information (which will be described later) is transmitted and received via the control bus B2 but control information (which will be described) may be transmitted and received via wireless communication according to any communication method capable of transmitting and receiving the control information, which will be described.

The processor 211 may include one or more processors or various processing circuits which include an arithmetic circuit such as a micro processing unit (MPU). The processor 211 is driven by power supplied from an internal power source (not shown) that includes the sensor system 201, such as a battery, or by power supplied from a power source external to the sensor system 201.

The processor 211 is an example of the processing device according to the embodiment. The processing device according to the embodiment can be applied to any circuit or any device capable of performing the processing in the processing unit which will be described (processing related to the control method according to the embodiment).

The processor 211 performs “control related to images output via the data bus B1 from the multiple sensors 212 connected to the data bus B1 (control related to the control method related to the embodiment)”.

The control related to images is performed for example in the processing unit 221 of the processor 211. In the processor 211, a specific processor (or specific processing circuit) or a plurality of processors (or a plurality of processing circuits) that perform image-related control serve as the processing unit 221.

The processing unit 221 is a part of the function of the processor 211 separated as appropriate. Therefore, in the processor 211, the image-related control according to the embodiment may be performed by multiple functional blocks. In the following example, the control related to images according to the embodiment is performed in the processing unit 221.

The processing unit 221 performs image-related control by transmitting control information to each of the sensors 212.

The control information according to the embodiment may include identification information indicating the sensor 212, information for control, and processing instructions. The identification information according to the embodiment may include an arbitrary kind of data that can be used to identify the sensor 212 such as an ID set on the sensor 212.

The control information is transmitted for example via the control bus B2 as described above.

The control information transmitted by the processing unit 221 is recorded for example in the register (an example of a recording medium) of each of the sensors 212. The sensor 212 outputs an image on the basis of the control information stored in the register.

The processing unit 221 performs, as the image-related control, any of the following control according to the first example in (1) to the fourth example in (4). Note that examples of output of images in the sensor system 201 that are realized by the image-related control according to the embodiment will be described later.

### (1) First Example of Image-Related Control: Image Concatenation Control

The processing unit 221 controls concatenation of multiple images output from the sensors 212.

In other words, the processing unit 221 controls concatenation of multiple images for example by controlling the start of a frame and the frame-end in each of the multiple images output from the sensors 212.

The start of a frame in each of the sensors 212 is controlled for example as the processing unit 221 controls output of a frame start packet in the sensor 212. The frame start packet is for example an “FS (Frame Start) packet” according to the CSI-2 standard. Hereinafter, the frame start packet may be referred to as an “FS” or “FS packet”.

The processing unit 221 controls output of the frame start packet at the sensor 212 by transmitting control information including data indicating whether to output the frame start packet (first output information, an example of information for control) to the sensor 212. An example of the data indicating whether to output the frame start packet of the frame includes a flag indicating whether to output the frame start packet.

The end of the frame at each of the sensors 212 is controlled for example as the processing unit 221 controls output of the end of a frame packet at each of the sensors 212. A frame-end packet is for example an “FE (Frame End) packet” according to the CSI-2 standard. In the following, the frame-end packet may be referred to as “FE” or “FE packet”.

For example, the processing unit 221 may transmit control information including data indicating whether to output a frame-end packet (second output information, an example of information for control) to the sensor 212 and thus control output of the frame end packet in the sensor 212. An example of the data indicating whether to output the frame-end packet includes a flag indicating whether to output the frame-end packet.

For example, as the processing unit 221 controls the start of a frame and the end of the frame in the plurality of images output from the sensors 212 as described above, data indicating the following images are output from the multiple sensors 212.
Data including a frame start packet and a frame end packet
Data including only a frame start packet
Data including only a frame-end packet
Data without a frame start packet and a frame end packet

The processor 211 configured to receive a plurality of images transmitted from the multiple sensors 212 via the data bus B1 recognizes that an image in a certain frame has started to be transmitted on the basis of the frame start packet included in the received image.

The processor 211 also recognizes that transmission of an image in a certain frame has ended on the basis of the frame end packet included in the received image.

The processor 211 is not aware that an image in a frame has started to be transmitted and that transmission of an image in a frame has ended unless a received image includes a frame start packet and a frame end packet. In the cases, the processor 211 may be aware that transmission of an image in a certain frame is in progress.

Therefore, using the processor 211 configured to receive a plurality of images transmitted from the multiple sensors 212 via the data bus B1 the processing shown in the following (a) and (b) is achieved. If any other processing circuit capable of processing images is connected to the data bus B1, processing of the images output from the multiple sensors 212 may be performed by the processing circuit. In the following example, the processing unit 221 provided by the processor 211 processes the images output from the multiple sensors 212.
(a) First example of processing images output from the multiple sensors 212 When data transmitted from one sensor 212 includes a frame start packet and a frame end packet, the processing unit 221 processes an image output from that one sensor 212 as a single image.
(b) A second example of processing images output from the multiple sensors 212. “When data transmitted from one sensor 212 includes a frame start packet and data transmitted from another sensor 212 received after the data including the frame start packet includes a frame end packet”, the processing unit 221 combines the image in the data containing the frame start packet with the image in the data including the frame end packet.

“In the above second example, when the data that does not include a frame start packet and a frame end packet transmitted from one or more other sensors 212 is received before the data that includes the frame end packet is received”, the processing unit 221 combines the image in the data that includes the frame start packet, the image in the data that does not include the frame start packet and the frame end packet, and the image in the data that includes the frame end packet.

The processing unit 221 combines the images transmitted from the multiple sensors 212 as described above on the basis of the frame start packet and the frame end packet, so that the plurality of images transmitted from the multiple sensors 212 are concatenated.

The control of concatenation of a plurality of images is not limited to the example described above.

For example, the processing unit 221 can further control concatenation of a plurality of images by controlling identifier assignment to the plurality of images output from the sensors 212.

The identifier according to the embodiment is data that can be used to identify an image output from the sensor 212. The identifier according to the embodiment may be one or both of a VC (Virtual Channel) value (sometimes referred to as “VC number”) specified in the CSI-2 standard and a DT (Data Type) value specified in the CSI-2 standard. The identifier according to the embodiment is not limited to the above examples but can be any kind of data that can be used to identify images in control of the concatenation of multiple images transmitted from multiple sensors 212.

The processing unit 221 can for example transmit data indicating the identifier of an image (third output information, an example of information for control) to the sensor 212 and thus controls identifier assignment to an image output from the sensor 212.

When the data transmitted from the sensor 212 includes an identifier, the processing unit 221 recognizes an image with a different identifier in a certain frame as a different image. When the identifiers are included in the data transmitted from the sensor 212, the processing unit 221 does not concatenate images with different identifiers.

Therefore, by further controlling the identifier assignment to the plurality of images output from the sensors 212 in addition to controlling the frame start and the frame end, the processing unit 221 can achieve more diverse control of image concatenation than the case of controlling the start of a frame and the end of the frame.

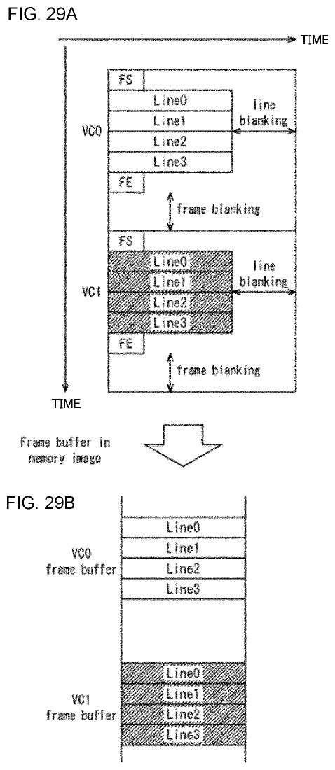

FIGS. 29 to 33 illustrate an example of control over images in the processor 211 that includes the sensor system 201 according to the embodiment. FIGS. 29 to 33 each illustrate an example of a result of controlling concatenation of images in the processor 211.

### (1-1) First Example of Control Result of Image Concatenation: FIG. 29

FIG. 29 at A illustrates an example of data corresponding to a certain frame obtained by the processor 211 from the two sensors 212 via the data bus B1. FIG. 29 at A illustrates an example of data received from one sensor 212 and the other sensor 212 as follows.
One sensor 212: data including image data per line, a frame start packet, a frame end packet, and a VC value “0” (an example of an identifier, and the same shall apply hereinafter).
The other sensor 212: data including image data per line, a frame start packet, a frame end packet, and a VC value “1” (an example of an identifier, and the same shall apply hereinafter.)

FIG. 29 at B illustrates a stored image when the data shown in FIG. 29 at A is stored in the frame buffer of the memory 213. The data shown in FIG. 29 at A may be stored in any other storage medium such as a storage medium of the processor 211.

When the data shown in FIG. 29 at A is received, the processing unit 221 records the images separately each in a frame buffer for each VC value as shown in FIG. 29 at B.

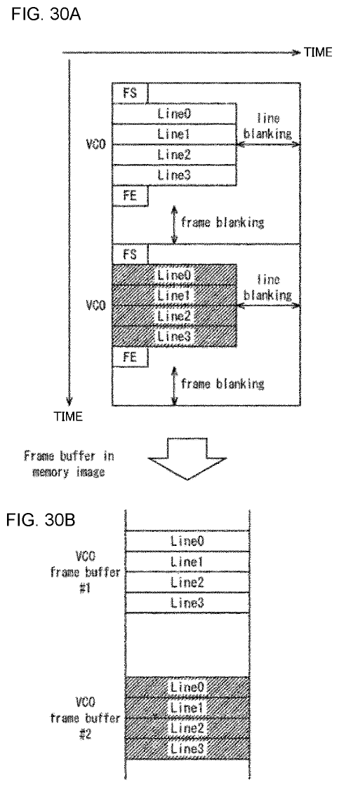

### (1-2) Second Example of Control Result of Image Concatenation: FIG. 30

FIG. 30 at A illustrates an example of data corresponding to a frame obtained by the processor 211 from two sensors 212 via the data bus B1. FIG. 30 at A illustrates an example of data received from one sensor 212 and the other sensor 212 as follows.
One sensor 212: data including image data per line, a frame start packet, a frame end packet, and a VC value “0”.
The other sensor 212: data including image data per line, a frame start packet, a frame end packet, and a VC value “0”.

When the data as shown in FIG. 30 at A is received, the processing unit 221 records the image in the frame buffer for the same VC value as shown in FIG. 30 at B. The image shown in FIG. 30 at B is stored for example using a double buffer.

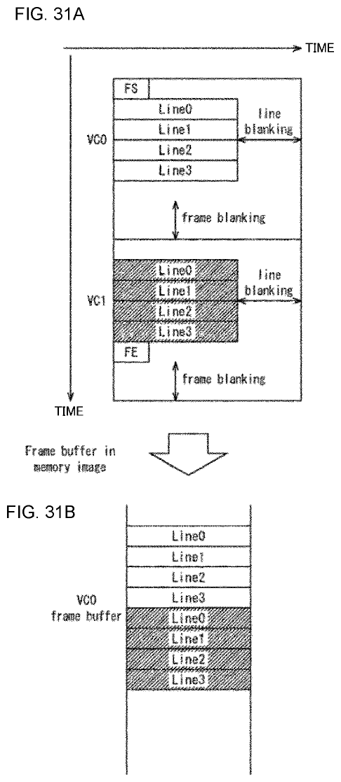

### (1-3) Third Example of Control Result of Image Concatenation: FIG. 31

FIG. 31 at A illustrates an example of data corresponding to a certain frame obtained by the processor 211 from two sensors 212 via the data bus B1. FIG. 31 at A illustrates an example of data received from one sensor 212 and the other sensor 212 as follows.
One sensor 212: data including image data per line, a frame start packet, and a VC value “0”.
The other sensor 212: data including image data per line, a frame end packet, and a VC value “0”.

When the data as shown in FIG. 31 at A is received, the processing unit 221 vertically concatenates the two images and records the images in the frame buffer as shown in FIG. 31 at B.

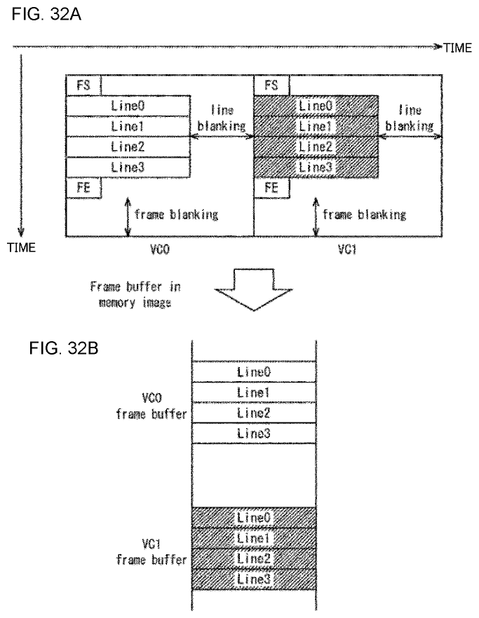

### (1-4) Fourth Example of Control Result of Image Concatenation: FIG. 32

FIG. 32 at A illustrates an example of data corresponding to a certain frame obtained by the processor 211 from two sensors 212 via the data bus B1. FIG. 32 at A illustrates an example of data received from one sensor 212 and the other sensor 212 as follows.
One sensor 212: data including image data per line, a frame start packet, a frame end packet, and a VC value “0”.
The other sensor 212: data including image data per line, a frame start packet, a frame end packet, and a VC value “1”.

When the data as shown in FIG. 32 at A is received, the processing unit 221 records the images separately each in a frame buffer for each VC value, as shown in FIG. 32 at B.

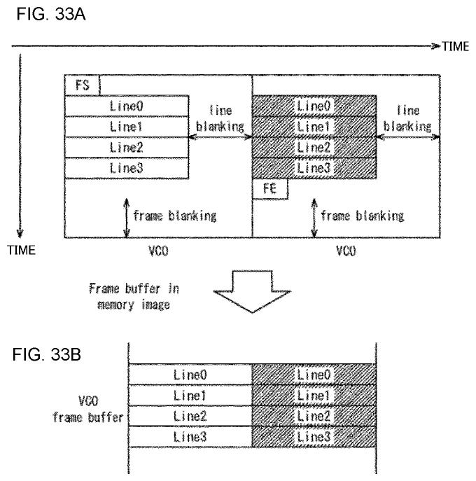

### (1-5) Fifth Example of Control Result of Image Concatenation: FIG. 33

FIG. 33 at A illustrates an example of data corresponding to a certain frame obtained by the processor 211 from two sensors 212 via the data bus B1. FIG. 33 at A illustrates an example of data received from one sensor 212 and the other sensor 212 as follows.
One sensor 212: data including image data per line, a frame start packet, and a VC value “0”.
The other sensor 212: data including image data per line, a frame end packet, and a VC value “0”.

When the data as shown in FIG. 33 at A is received, the processing unit 221 concatenates the two images horizontally and records the resulting image in a frame buffer as shown in FIG. 33 at B.

By controlling the concatenation of images in the processing unit 221 of the processor 211, the images are selectively concatenated for example as shown in FIGS. 29 to 33. It should be understood that examples of the results of the control of the concatenation of images by the processing unit 221 of the processor 100 are not limited to the examples shown in FIGS. 29 to 33.

### (2) Second Example of Control of Images: Control of Images to be Output

The processing unit 221 controls images to be output from the sensors 212. Examples of control of images output from the sensors 212 according to the embodiment may include one or both of control of the size of an image to be output from each of the sensors 212 and control of the frame rate of an image to be output from each of the sensors 212.

For example, the processing unit 221 controls images to be output from the sensors 212 by transmitting control information including one or both of data indicating the image size and data indicating the frame rate (an example of information for control) to the sensors 212.

### (3) Third Example of Image Related Control: Control of Image Output Timing

The processing unit 221 controls the output timing for images to be output from the image sensors.

For example, the processing unit 221 controls the output timing for images to be output from the sensor 212 by transmitting control information to the sensor 212, including data indicating an output delay amount (an example of information for control) from reception of an image output command to output of the image.

### (4) Fourth Example of Control Over Images

The processing unit 221 may perform two or more kinds of control according to the first example shown in (1) to the third example shown in (3).

The processing unit 221 performs, as image-related control, control concerning images, for example, control as in the first example shown in (1) to control according to the fourth example shown in (4).

The processor 211 performs the processing related to the image-related control as described above (processing related to the control method according to the embodiment) for example by providing the processing unit 221.

The processing performed in the processor 211 is not limited to the processing according to the image-related control as described above.

For example, the processor 211 can perform various kinds of processing such as processing related to control of recording image data to a recording medium such as the memory 213, processing related to control of displaying images on the display screen of the display device 214, processing to execute any application software, as shown in FIGS. 29 to 33. The processing related to recording control may include “transferring control data including recording commands and data to be recorded on the recording medium to a recording medium such as the memory 213”. The processing related to display control may include “transmitting control data including display commands and data to be displayed on a display screen to a display device such as the display device 214”.

The sensor 212 is an image sensor. The image sensor according to the embodiment includes an imaging device such as a digital still camera, a digital video camera, and a stereo camera and an arbitrary sensor device such as an infrared sensor and a distance image sensor and has the function of outputting generated images. Here, an image generated by the sensor 212 corresponds to data indicating a sensing result by the sensor 212.

The sensor 212 is connected to the data bus B1 which are connected with other sensors 212 as shown in FIG. 28.

The sensor 212 outputs an image on the basis of the control information. As described above, the control information is transmitted from the processor 211, and the sensor 212 receives the control information via the control bus B2.

### <Example of Transmission Method>

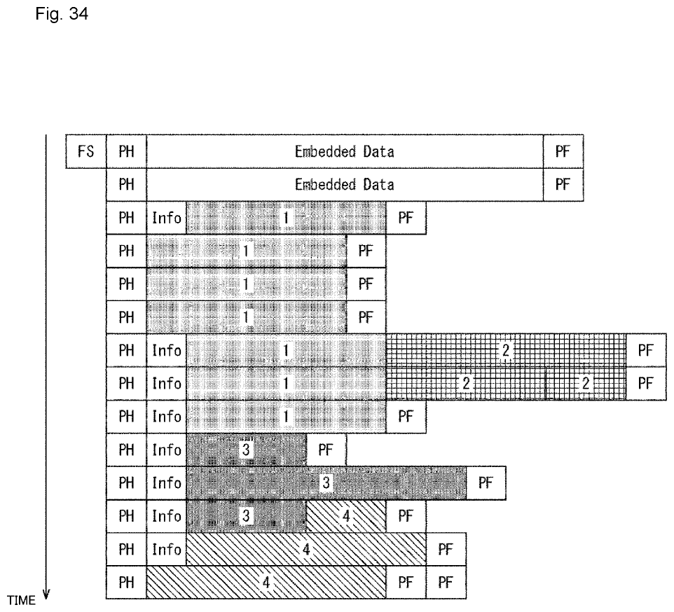

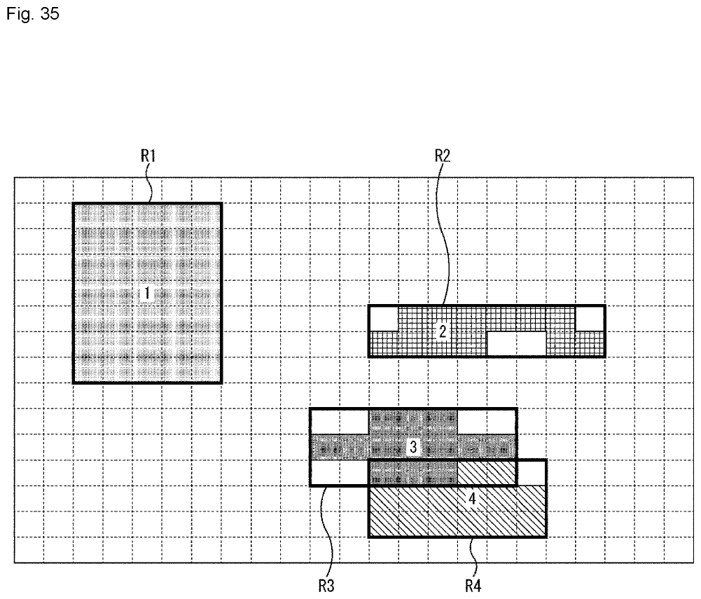

Referring to FIGS. 34 and 35, an example of a transmission method from the sensor 212 to the processor 211 will be described.

The sensor 212 stores region information and region data in the payload of a packet and causes the information and the data to be transmitted on a row basis. For example, the sensor 212 sets region information corresponding to a region set for the image including event data for each row in the image by the additional information generation unit 23 and transmits the set region information and the event data that is the region data corresponding to the region for the row. The sensor 212 causes the region information and the region data for each row to be transmitted according to a predetermined order, for example, in ascending or descending order of y-coordinate values. The sensor 212 may also cause region information and region data for each row to be transmitted in a random order. Here, the region information is data (a group of data pieces) used to identify the region set for the image on the receiving device side. The region information may include information indicating the location of the row, identification information about the region included in the row, information indicating the location of the column of the region included in the row, and information indicating the size of the region included in the row.

FIG. 34 illustrates an example of data transmitted by the first transmission method according to the transmission method. In the example shown in FIG. 34, region information and region data (event data about a region 1, event data about a region 2, event data about a region 3, and event data about a region 4) corresponding to the region 1, the region 2, the region 3, and the region 4 shown in FIG. 35 are stored in the payload of an MIPI long packet and transmitted on a row-basis.

In FIG. 34, “FS” indicates the FS (Frame Start) packet in the MIPI CSI-2 standard, and “FE” in FIG. 34 is the FE (Frame End) packet in the MIPI CSI-2 standard (the same applies to other figures).

“Embedded Data” shown in FIG. 34 is data that can be embedded in the header or footer of data to be transmitted. The “Embedded Data” may include additional information additionally transmitted by the sensor 212. Hereinafter, the Embedded Data is sometimes referred to as “EBD”.

The additional information may include one or more kinds of information indicating the amount of data in the region, information indicating the size of the region, and information indicating the priority of the region.

The information indicating the amount of data in the region can be data in any format that can identify the amount of data in the region, such as “data indicating the number of pixels in the region (or the amount of data in the region) and the amount of data in the header”. By transmitting information indicating the amount of data in a region as “Embedded Data” as shown in FIG. 34, the receiving device can determine the amount of data in each region. More specifically, by transmitting the information indicating the data amount in the region as the “Embedded Data” in FIG. 34, the receiving device can identify the data amount in the region if the receiving unit does not have a function to calculate the amount of data in the region on the basis of the region information.

The information indicating the size of a region can be data in any format capable of identifying the size of a region, such as, for example, “data indicating the rectangular region containing the region (e.g., data indicating the number of pixels in the horizontal direction and the number of pixels in the vertical direction in said rectangular region).

Information indicating the priority of a region is, for example, data used in processing the data of the region. For example, the priority level indicated by the information indicating the priority level of the region is used for the order in which the regions are processed and for processing when the set regions overlap, such as in the case of regions 3 and 4 shown in FIG. 35.

The additional information according to the embodiment is not limited to the above examples. For example, the additional information according to the embodiment includes various types of data, such as exposure information indicating an exposure value in the image sensor device, and gain information indicating a gain in the image sensor device. The exposure value indicated by the exposure information and the gain indicated by the gain information are set in the image sensor device by control by the processor 211 via the control bus B2.

FIG. 35 illustrates an example of Embedded Data transmitted by the first transmission method for the transmission method. In the example shown in FIG. 35, information indicating the size of the region is transmitted as the “Embedded Data” shown in FIG. 34, and the information indicating the size of the region to be transmitted is data indicating the smallest rectangular region that includes the region. In the example shown in FIG. 35, four regions, a region 1, a region 2, a region 3, and a region 4 are set.

By transmitting information indicating the size of the region as the “Embedded Data” shown in FIG. 34, the receiving device can identify the smallest rectangular region including the region 1 indicated by R1 in FIG. 35, the smallest rectangular region including the region 2 indicated by R2 in FIG. 35, the smallest rectangular region including the region 3 indicated by R3 in FIG. 35, and the smallest rectangular region including the region 4 indicated by R4 in FIG. 35. In other words, by transmitting the information indicating the size of the region as the “Embedded Data” shown in FIG. 34, the receiving device is allowed to identify the smallest rectangular region that includes each region on the basis the region information if the receiving device does not have a function to identify the smallest rectangular region that includes the region on the basis of the region information. It should be understood that the information indicating the size of the region is not limited to the data indicating the smallest rectangular region that includes each region.

The information indicating the priority of the regions can be data in any format that can be used to identify the priority of the regions, for example, data having ROI IDs arranged in descending or ascending order of priority. By transmitting the information indicating the priority of the regions as the “Embedded Data” shown in FIG. 34, the receiving device can identify the order of processing the regions and which region is to be processed with priority. In other words, by transmitting the information indicating the priority of the regions as the “Embedded Data” shown in FIG. 34, the receiving device can control processing of the regions.

It should be understood that examples of information indicating the amount of data in a region, information indicating the size of a region, and information indicating the priority of regions, each of which is transmitted as “Embedded Data” as shown in FIG. 34, are not limited to the examples shown above.

In FIG. 34, “PH” designates the packet header of a long packet. Here, the packet header of a long packet according to the first transmission method may function as data (change information) indicating whether information included in the region information has changed from the region information included in the packet to be immediately previously transmitted. In other words, “PH” shown in FIG. 34 can be considered as data indicating the data type of the long packet.

In one example, the sensor 212 sets “PH” to “0x38” when the information included in the region information has changed from the region information included in the packet to be transmitted immediately before. In this case, the sensor 212 stores the region information in the payload of the long packet.

In another example, the sensor 212 sets “PH” to “0x39” when the information included in the region information has not changed from the region information included in the packet to be immediately previously transmitted. In this case, the sensor 212 does not store the region information in the payload of the long packet. In other words, if the information included in the region information has not changed from the region information included in the packet to be transmitted immediately previously, the sensor 212 prevents the region information from being transmitted.

It should be understood that the data set as “PH” is not limited to the above examples.

The “Info” shown in FIG. 34 is region information stored in the payload (the same applies to other figures). As shown in FIG. 34, the region information is stored at the start of the payload. For example, the region information may be indicated by “ROI Info”.

The “1”, “2”, “3”, and “4” shown in FIG. 34 correspond to the region data about the region 1, region data about the region 2, region data about the region 3, and region data about the region 4, respectively, which are stored in the payload (the same applies to other figures). In FIG. 34, each piece of the region data is shown separated, but the data stored in the payload is not separated (the same is true in the other figures). For example, region data may be indicated by “ROI DATA”.

### <Exemplary Use of Image Sensor>

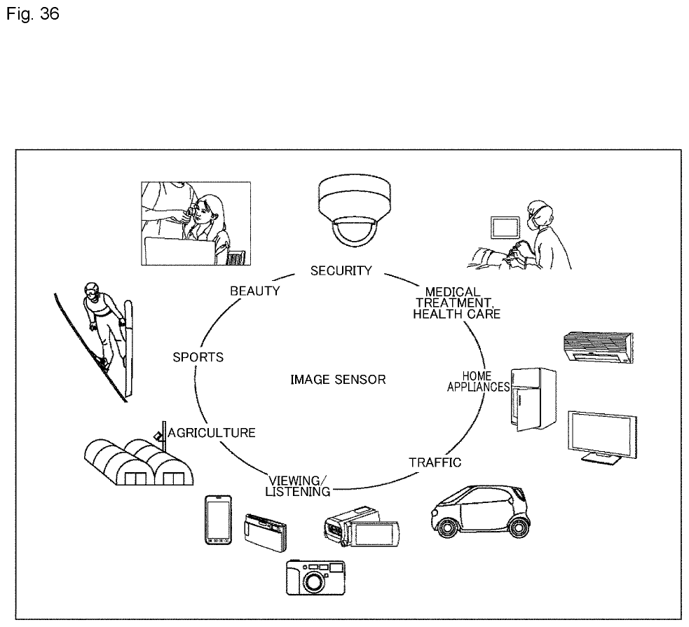

FIG. 36 illustrates an exemplary use of the above-described image sensor (EVS 12).

The image sensor described above can be used in various cases for sensing for example visible light, infrared light, ultraviolet light, and X-rays, which will be described.
Devices that capture images used for viewing, such as digital cameras and mobile devices with camera functions
Devices used for transportation, such as in-vehicle sensors that capture front, rear, surrounding, and interior view images of automobiles, monitoring cameras that monitor traveling vehicles and roads, ranging sensors that measure a distance between vehicles, and the like, for safe driving such as automatic stop, recognition of a driver's condition, and the like
Devices used for home appliances such as TVs, refrigerators, and air conditioners in order to capture an image of a user's gesture and perform device operations in accordance with the gesture
Devices used for medical treatment and healthcare, such as endoscopes and devices that perform angiography by receiving infrared light
Devices used for security, such as monitoring cameras for crime prevention and cameras for personal authentication
Devices used for beauty, such as a skin measuring device that captures images of the skin and a microscope that captures images of the scalp
Devices used for sports, such as action cameras and wearable cameras for sports applications
Devices used for agriculture, such as cameras for monitoring conditions of fields and crops

### <Examples of Configuration Combinations>

The present disclosure can also be configured as follows.

(1)

An image sensor comprising: an event detection unit configured to detect an occurrence of an event as a luminance change in light received by a photodiode; and
a data transmission unit configured to transmit data in such a frame structure that event data indicating a content of the event is a part of payload data and frame information to be added to a frame as additional information additionally provided to the event data is a part of embedded data.
   (2)

The image sensor according to (1), wherein the frame information is arranged in a start position of the event data including a plurality of lines, an end position of the event data, an intermediate position of the event data or the start and end positions of the event data.

(3)

The image sensor according to (1) or (2), wherein the data transmission unit concatenates a plurality of frames of the event data as subframes and transmits a result as one frame.

(4)

The image sensor according to any one of (1) to (3), wherein the additional information includes a timestamp or a frame number related to the event data.

(5)

The image sensor according to any one of (1) to (4), wherein the additional information includes an event detection threshold generated on the basis of the event data or ROI (Region of Interest) information.

(6)

The image sensor according to any one of (1) to (5), wherein the additional information includes flicker information generated on the basis of the event data.

(7)

The image sensor according to any one of (1) to (6), wherein the additional information includes an optical flow indicating whether there is movement of a subject generated on the basis of the event data or a moving direction thereof.

(8)

The image sensor according to any one of (1) to (7), wherein the additional information includes a data amount of the frame.

(9)

The image sensor according to any one of (1) to (8), wherein when the event detection unit is an arbiter type device,
a frame for one frame including the event data to be output from the event detection unit at the timing of event occurrence.
   (10)

The image sensor according to (1) to (9), wherein the data transmission unit sets region information corresponding to a region set for an image of the event data for each row in the image and transmits, for each row, the set region information and the event data to serve as region data corresponding to the region, and the region information includes information indicating a row position and a column position of the region included in the row.

(11)

The image sensor according to any one of (1) to (10), further comprising a luminance detection unit configured to detect a luminance of light received by the photodiode and output a luminance signal representing a luminance value thereof, and
an additional information generation unit configured to generate the frame information as additional information provided additionally to the event data on the basis of the event data,
wherein
the event detection unit obtains a difference between the luminance value represented by the luminance signal and a prescribed reference value, detects an occurrence of the event and outputs the event data indicating the content of the event when the difference exceeds an event detection threshold on a positive side or an event detection threshold on a negative side.
   (12)

A data processing device including: a data receiving unit configured to receive data in such a frame structure that event data indicating a content of an event as a luminance change in light received by a photodiode is a part of payload data and frame information to be added to a frame as additional information additionally provided to the event data is a part of embedded data; and an event-related data processing unit configured to perform data processing related to the event by referring to the frame information.

(13)

The data processing device according to (12), wherein the data receiving unit receives
region information set corresponding to a region set for an image of the event data and for each row in the image, and
the event data to serve as region data corresponding to the region, and
the region information includes information indicating a row position and a column position of the region included in the row.
   (14)

The data processing device according to (12) or (13), further comprising a processing unit connected to a data bus to control an image of the event data output via the data bus from each of a plurality of image sensors that output the event data,
wherein
the processing unit performs output control of a frame start packet in each of the image sensors and a frame end packet in each of the image sensors and control to concatenate a plurality of images from an image including a start packet to an image including an end packet for a plurality of images output from each of the image sensors.
   (15)

An image sensor system comprising:
an image sensor having an event detection unit configured to detect an occurrence of an event as a luminance change in light received by a photodiode and
a data transmission unit configured to transmit data in such a frame structure that event data indicating a content of the event as a part of payload data and frame information to be added to a frame as additional information provided to the event data is a part of embedded data;
and
a data processing device having a data receiving unit configured to receive the event data and the frame information, and
an event-related data processing unit configured to perform data processing related to the event by referring to the frame information.
   (16)

The image sensor system according to (15), wherein data is serially converted and transmitted between the image sensor and the data processing device, and serial conversion according to one standard and serial conversion according to another standard are switchable on the image sensor side and the data processing device side.

(17)

The image sensor system according to (15) or (16), wherein the data transmission unit sets, for each row in an image of the event data, region information corresponding to a region set for the image and transmits the set region information and the event data to serve as region data corresponding to the region for each row,
the data receiving unit receives the region information and the event data to serve as the region data, and
the region information includes information indicating a row position and a column position of the region included in the row.
   (18)

The image sensor system according to any one of (15) to (17), wherein the data processing device includes
a processing unit connected to a data bus to perform control related to an image of the event data output via the data bus from the plurality of image sensors that output the event data,
the processing unit performs output control of a frame start packet in each of the image sensors and a frame end packet in each of the image sensors, and the processing unit performs control to concatenate a plurality of images from an image including a start packet to an image including an end packet for a plurality of images output from the image sensors.

Note that embodiments of the present disclosure are not limited to the above-mentioned embodiments and can be modified in various manners without departing from the scope and spirit of the present disclosure. The advantageous effects described in the present specification are merely exemplary and are not limitative, and other advantageous effects may be achieved.

### REFERENCE SIGNS LIST

11 Sensor system
12 EVS
13 Data processing unit
14 Data bus
21 Luminance detection unit
22 Event detection unit
23 Additional information generation unit
24 Data transmission unit
25 Pixel chip
26 Signal processing chip
27 AFE chip
28 Logic chip
31 Data receiving unit
32 Event-related data processing unit
41 Event access unit
42 Event count unit
43 Event count analysis unit
44 Event count frequency analysis unit
45 Optical flow analysis unit
46 Data amount calculation unit
47 Frame generation unit
48 SRAM
49 Data amount calculation unit
50 Data compression unit
51 Attention calculation unit
52 Data processing unit

1. An image sensor comprising: an event detection unit configured to detect an occurrence of an event as a luminance change in light received by a photodiode; and
a data transmission unit configured to transmit data in such a frame structure that event data indicating a content of the event is a part of payload data and frame information to be added to a frame as additional information additionally provided to the event data is a part of embedded data.

2. The image sensor according to claim 1, wherein the frame information is arranged in a start position of the event data including a plurality of lines, an end position of the event data, an intermediate position of the event data or the start and end positions of the event data.

3. The image sensor according to claim 1, wherein the data transmission unit concatenates a plurality of frames of the event data as subframes and transmits a result as one frame.

4. The image sensor according to claim 1, wherein the additional information includes a timestamp or a frame number related to the event data.

5. The image sensor according to claim 1, wherein the additional information includes an event detection threshold generated on the basis of the event data or ROI (Region of Interest) information.

6. The image sensor according to claim 1, wherein the additional information includes flicker information generated on the basis of the event data.

7. The image sensor according to claim 1, wherein the additional information includes an optical flow indicating whether there is movement of a subject generated on the basis of the event data or a moving direction thereof.

8. The image sensor according to claim 1, wherein the additional information includes a data amount of the frame.

9. The image sensor according to claim 1, wherein when the event detection unit is an arbiter type device,
a frame for one frame including the event data to be output from the event detection unit at the timing of event occurrence.

10. The image sensor according to claim 1, wherein the data transmission unit sets region information corresponding to a region set for an image of the event data for each row in the image and transmits, for each row, the set region information and the event data to serve as region data corresponding to the region, and the region information includes information indicating a row position and a column position of the region included in the row.

11. The image sensor according to claim 1, further comprising a luminance detection unit configured to detect a luminance of light received by the photodiode and output a luminance signal representing a luminance value thereof; and
an additional information generation unit configured to generate the frame information as additional information provided additionally to the event data on the basis of the event data,
wherein
the event detection unit obtains a difference between the luminance value represented by the luminance signal and a prescribed reference value, detects an occurrence of the event and outputs the event data indicating the content of the event when the difference exceeds an event detection threshold on a positive side or an event detection threshold on a negative side.

12. A data processing device comprising:
a data receiving unit configured to receive data in such a frame structure that event data indicating a content of an event as a luminance change in light received by a photodiode is a part of payload data and frame information to be added to a frame as additional information additionally provided to the event data is a part of embedded data; and
an event-related data processing unit configured to perform data processing related to the event by referring to the frame information.

13. The data processing device according to claim 12, wherein the data receiving unit receives
region information set corresponding to a region set for an image of the event data and for each row in the image, and
the event data to serve as region data corresponding to the region, and the region information includes information indicating a row position and a column position of the region included in the row.

14. The data processing device according to claim 12, further comprising a processing unit connected to a data bus to control an image of the event data output via the data bus from each of a plurality of image sensors that output the event data, wherein
the processing unit performs output control of a frame start packet in each of the image sensors and a frame end packet in each of the image sensors and control to concatenate a plurality of images from an image including a start packet to an image including an end packet for a plurality of images output from each of the image sensors.

15. An image sensor system comprising: an image sensor having an event detection unit configured to detect an occurrence of an event as a luminance change in light received by a photodiode and
a data transmission unit configured to transmit data in such a frame structure that event data indicating a content of the event as a part of payload data and frame information to be added to a frame as additional information provided to the event data is a part of embedded data; and
a data processing device having a data receiving unit configured to receive the event data and the frame information, and
an event-related data processing unit configured to perform data processing related to the event by referring to the frame information.

16. The image sensor system according to claim 15, wherein data is serially converted and transmitted between the image sensor and the data processing device, and
serial conversion according to one standard and serial conversion according to another standard are switchable on the image sensor side and the data processing device side.

17. The image sensor system according to claim 15, wherein the data transmission unit sets, for each row in an image of the event data, region information corresponding to a region set for the image and transmits the set region information and the event data to serve as region data corresponding to the region for each row,
the data receiving unit receives the region information and the event data to serve as the region data, and
the region information includes information indicating a row position and a column position of the region included in the row.

18. The image sensor system according to claim 15, wherein the data processing device includes
a processing unit connected to a data bus to perform control related to an image of the event data output via the data bus from the plurality of image sensors that output the event data,
the processing unit performs output control of a frame start packet in each of the image sensors and a frame end packet in each of the image sensors, and
the processing unit performs control to concatenate a plurality of images from an image including a start packet to an image including an end packet for a plurality of images output from the image sensors.
